(19) United States
(12) Patent Application Publication
(10) Pub. No.: US 2016/0190578 A1
(43) Pub. Date: Jun. 30, 2016

(54) Storage battery

(71) Applicant: SEMICONDUCTOR ENERGY LABORATORY CO., LTD., Atsugi-shi (JP)

(72) Inventors: Junpei MOMO, Sagamihara (JP); Takahiro KAWAKAMI, Atsugi (JP); Yohei MOMMA, Isehara (JP)

(73) Assignee: SEMICONDUCTOR ENERGY LABORATORY CO., LTD.

(21) Appl. No.: 14/757,444

(22) Filed: Dec. 23, 2015

(30) Foreign Application Priority Data
Dec. 26, 2014 (JP) 2014-264207

(51) Int. Cl. H01M 4/505; H01M 10/0525

(52) U.S. Cl. CPC H01M 4/505; H01M 10/0525; H01M 2220/30

(57) ABSTRACT

An object is to provide a storage battery using materials for an electrode active material without waste. Another object is to provide an electrode active material with an appropriate compounding ratio. A lithium-ion storage battery includes a positive electrode, a negative electrode, and an electrolytic solution therebetween. The positive electrode includes a positive electrode current collector and a positive electrode active material layer. The positive electrode active material layer includes a first positive electrode active material and a second positive electrode active material. The charge capacity of the first positive electrode active material is higher than the discharge capacity thereof. The discharge capacity of the second positive electrode active material is higher than the charge capacity thereof. The first positive electrode active material may be a lithium-manganese composite oxide, and the second positive electrode active material may be a lithium-manganese oxide with a spinel crystal structure.

### BACKGROUND OF THE INVENTION

1. Field of the Invention

One embodiment of the present invention relates to a lithium-ion storage battery and a method for manufacturing the lithium-ion storage battery.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method for driving any of them, and a method for manufacturing any of them.

2. Description of the Related Art

Examples of the storage battery include a nickel-metal hydride storage battery, a lead-acid storage battery, and a lithium-ion storage battery.

Such storage batteries are used as power sources in portable information terminals typified by mobile phones. In particular, lithium-ion storage batteries have been actively developed because the capacity thereof can be increased and the size thereof can be reduced.

A major challenge in developing lithium-ion storage batteries is increasing capacity, which leads to a longer operating time and a lighter weight for mobile uses and to a longer driving distance for automobile uses. For example, a positive electrode active material is an important factor determining the amount of the lithium ions contributing to a battery reaction. A negative electrode active material is also an important factor since it needs to cause a reversible reaction with lithium ions whose amount is the same as in the positive electrode.

As examples of materials for a positive electrode active material of a lithium-ion storage battery, phosphate compounds having an olivine structure and containing lithium and iron, manganese, cobalt, or nickel, such as lithium iron phosphate (LiFePO₄), lithium manganese phosphate (LiMnPO₄), lithium cobalt phosphate (LiCoPO₄), and lithium nickel phosphate (LiNiPO₄), which are disclosed in Patent Document 1, are known. Examples of materials for a negative electrode active material are, in addition to a graphite material, silicon, tin, and oxides thereof disclosed as high-capacity materials in Patent Document 2, for example.

A material for a positive electrode active material which has high charge capacity and high irreversible capacity in discharging when used for a positive electrode is known: the discharge capacity of the material for the positive electrode active material is lower than the charge capacity thereof, and the positive electrode including such a material has low initial charge and discharge efficiency. That is, lithium that is released in charging is not partly taken in the positive electrode active material in discharging. In order to use such a material as a positive electrode active material for a storage battery, the storage battery needs to have negative electrode capacity corresponding to the irreversible capacity as well as negative electrode capacity corresponding to the reversible capacity of the positive electrode. Therefore, an increase in the weight of a negative electrode is caused, the storage battery increases in weight and volume, and the capacity of the storage battery per unit weight and unit volume is reduced. An example of such a material for a positive electrode active material is Li₂MnO₃ (Non-Patent Document 1).

A positive electrode material whose charge capacity is not significantly high, but whose theoretical discharge capacity is high and which is overdischarged is also known. That is, in discharging, the amount of lithium that exceeds the amount of lithium released in charging can be received by a positive electrode active material.

However, the amount of lithium ions regarding reaction in a storage battery depends on the amount of charge that reacts in a positive electrode in the initial charging; thus, the amount of lithium ions corresponding to overdischarge cannot be used for reaction. An example of such a positive electrode material is LiMn₂O₄ (Non-Patent Document 1).

### REFERENCES

### Patent Documents

[Patent Document 1] Japanese Published Patent Application No. H11-25983
[Patent Document 2] Japanese Published Patent Application No. 2007-106634

### Non-Patent Document

[Non-Patent Document 1] The Electrochemical Society of Japan ed., Denchi Handobukku (Handbook of batteries), Ohmsha, Ltd., Feb. 10, 2010, pp. 450-467

### SUMMARY OF THE INVENTION

In order to utilize overdischarge for a battery reaction in a storage battery including a material for a positive electrode active material that can be overdischarged like LiMn₂O₄, that is, a material for a positive electrode active material in which the amount of lithium that exceeds the amount of lithium released in charging can be taken in discharging, for example, a reaction other than release of lithium in charging such as an oxidation decomposition reaction of an electrolytic solution is caused, metallic lithium is used for a negative electrode, or a negative electrode is pre-doped with lithium for a reaction in advance. However, the decomposition of an electrolytic solution adversely affects the storage battery; for example, a gas is generated or resistance is increased. Using metallic lithium for the negative electrode might adversely affect the safety of the storage battery. Furthermore, pre-doping the negative electrode with lithium involves a complicated process for stably doping with lithium, which is unstable; thus, it is difficult to improve productivity.

In view of the above, an object of one embodiment of the present invention is to provide a storage battery with high capacity per unit mass and unit volume. Another object is to provide a storage battery using materials for an electrode active material without waste. Another object is to provide an electrode active material with an appropriate compounding ratio. Another object is to provide a method for manufacturing a storage battery including an electrode active material with an appropriate compounding ratio. Another object of one embodiment of the present invention is to provide a method for manufacturing a storage battery with high capacity per unit mass and unit volume. Another object of one embodiment of the present invention is to provide a novel storage battery, a novel power storage device, a method for manufacturing a novel storage battery, or a method for manufacturing a novel power storage device.

Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the present invention is a lithium-ion storage battery including a positive electrode, a negative electrode, and an electrolytic solution between the positive electrode and the negative electrode. The positive electrode includes a positive electrode current collector and a positive electrode active material layer. The positive electrode active material layer includes a first positive electrode active material and a second positive electrode active material. The charge capacity of the first positive electrode active material is higher than the discharge capacity of the first positive electrode active material. The discharge capacity of the second positive electrode active material is higher than the charge capacity of the second positive electrode active material.

Another embodiment of the present invention is a lithium-ion storage battery including a positive electrode, a negative electrode, and an electrolytic solution between the positive electrode and the negative electrode. The positive electrode includes a positive electrode current collector and a positive electrode active material layer. The positive electrode active material layer includes a first positive electrode active material and a second positive electrode active material. The charge capacity of the first positive electrode active material is higher than the discharge capacity of the first positive electrode active material. The discharge capacity of the second positive electrode active material is higher than the charge capacity of the second positive electrode active material. The difference between the charge capacity and the discharge capacity of the first positive electrode active material is larger than the difference between the discharge capacity and the charge capacity of the second positive electrode active material. The proportion of the first positive electrode active material is higher than the proportion of the second positive electrode active material in the positive electrode active material layer.

Another embodiment of the present invention is a lithium-ion storage battery including a positive electrode, a negative electrode, and an electrolytic solution between the positive electrode and the negative electrode. The positive electrode includes a positive electrode current collector and a positive electrode active material layer. The positive electrode active material layer includes a first positive electrode active material and a second positive electrode active material. The charge capacity of the first positive electrode active material is higher than the discharge capacity of the first positive electrode active material. The discharge capacity of the second positive electrode active material is higher than the charge capacity of the second positive electrode active material. The capacity obtained by multiplying the difference between the charge capacity and the discharge capacity of the first positive electrode active material by the weight proportion of the first positive electrode active material in the positive electrode active material layer is lower than or equal to the capacity obtained by multiplying the difference between the discharge capacity and the charge capacity of the second positive electrode active material by the weight proportion of the second positive electrode active material in the positive electrode active material layer.

Another embodiment of the present invention is a lithium-ion storage battery including a positive electrode, a negative electrode, and an electrolytic solution between the positive electrode and the negative electrode. The positive electrode includes a positive electrode current collector and a positive electrode active material layer. The positive electrode active material layer includes a first positive electrode active material and a second positive electrode active material. The charge capacity of the first positive electrode active material is higher than the discharge capacity of the first positive electrode active material. The discharge capacity of the second positive electrode active material is higher than the charge capacity of the second positive electrode active material. The difference between the charge capacity and the discharge capacity of the first positive electrode active material is larger than the difference between the discharge capacity and the charge capacity of the second positive electrode active material. The proportion of the first positive electrode active material in the positive electrode active material layer satisfies Formula (1).

$${R}_{1} = \frac{( {Q}_{c 2} - {Q}_{d 2} )}{( {Q}_{c 2} - {Q}_{d 2} ) - ( {Q}_{c 1} - {Q}_{d 1} )} \qquad ( 1 )$$

In Formula (1), R₁ represents the weight proportion of the first positive electrode active material in the positive electrode active material layer; Q_{c1} represents the charge capacity of the first positive electrode active material, and Q_{d1} represents the discharge capacity of the first positive electrode active material; and Q_{c2}t represents the charge capacity of the second positive electrode active material, and Q_{d2} represents the discharge capacity of the second positive electrode active material. In one embodiment of the present invention, the first positive electrode active material is a lithium-manganese composite oxide, and the second positive electrode active material is a lithium-manganese oxide with a spinel crystal structure.

According to one embodiment of the present invention, a storage battery with high capacity per unit mass and unit volume can be provided. According to one embodiment of the present invention, a storage battery using materials for an electrode active material without waste can be provided. According to one embodiment of the present invention, an electrode active material with an appropriate compounding ratio can be provided. According to one embodiment of the present invention, a method for manufacturing a storage battery including an electrode active material with an appropriate compounding ratio can be provided. According to one embodiment of the present invention, a method for manufacturing a storage battery with high capacity per unit mass and unit volume can be provided. According to one embodiment of the present invention, a novel storage battery, a novel power storage device, a method for manufacturing a novel storage battery, or a method for manufacturing a novel power storage device can be provided.

### BRIEF DESCRIPTION OF THE DRAWINGS

FIGS. 1A and 1B illustrate a lithium-ion storage battery of one embodiment of the present invention.

FIGS. 2A to 2D each show a radius of curvature.

FIGS. 3A to 3C show a radius of curvature.

FIGS. 4A to 4C illustrate a coin-type storage battery.

FIGS. 5A and 5B illustrate a cylindrical storage battery.

FIGS. 6A and 6B illustrate a laminated storage battery.

FIG. 7 is an external view of a storage battery.

FIG. 8 is an external view of a storage battery.

FIGS. 9A to 9C illustrate a method for manufacturing a storage battery.

FIGS. 10A to 10E illustrate flexible laminated storage batteries.

FIGS. 11A and 11B illustrate an example of a power storage device.

FIGS. 12A1, 12A2, 12B1, and 12B2 illustrate examples of a power storage device.

FIGS. 13A and 13B each illustrate an example of a power storage device.

FIGS. 14A and 14B each illustrate an example of a power storage device.

FIG. 15 illustrates an example of a power storage device.

FIGS. 16A and 16B illustrate application examples of a power storage device.

FIG. 17 shows charge and discharge characteristics of Positive Electrode 1 of Example, Comparative Positive Electrode 1, and Comparative Positive Electrode 2.

FIGS. 18A to 18C illustrate a modification example of a storage battery.

FIGS. 19A to 19D illustrate a modification example of a storage battery.

FIGS. 20A, 20B, 20C1, 20C2, and 20D illustrate a modification example of a storage battery.

FIGS. 21A to 21D illustrate a modification example of a storage battery.

FIG. 22 is a block diagram illustrating one embodiment of the present invention.

FIGS. 23A to 23C are each a conceptual diagram illustrating one embodiment of the present invention.

FIG. 24 is a circuit diagram illustrating one embodiment of the present invention.

FIG. 25 is a circuit diagram illustrating one embodiment of the present invention.

FIGS. 26A to 26C are each a conceptual diagram illustrating one embodiment of the present invention.

FIG. 27 is a block diagram illustrating one embodiment of the present invention. FIG. 28 is a flow chart showing one embodiment of the present invention.

### DETAILED DESCRIPTION OF THE INVENTION

Embodiments of the present invention will be described below in detail with reference to the accompanying drawings. Note that the present invention is not limited to the description below, and it is easily understood by those skilled in the art that modes and details disclosed herein can be modified in various ways. Therefore, the present invention should not be construed as being limited to the description in the following embodiments.

Note that in each drawing described in this specification, the size or the thickness of each component such as a positive electrode, a negative electrode, an active material layer, a separator, an exterior body, and the like is exaggerated for clarity in some cases. Therefore, the sizes of the components are not limited to the sizes in the drawings and relative sizes between the components.

Ordinal numbers such as “first,” “second,” and “third” are used for convenience and do not denote the order of steps or the stacking order of layers. Therefore, for example, description can be made even when “first” is replaced with “second” or “third,” as appropriate. In addition, the ordinal numbers in this specification and the like are not necessarily the same as those which specify one embodiment of the present invention.

Note that in the structures of the present invention described in this specification and the like, the same portions or portions having similar functions in different drawings are denoted by the same reference numerals, and description of such portions is not repeated. Further, the same hatching pattern is applied to portions having similar functions, and the portions are not especially denoted by reference numerals in some cases.

In this specification, flexibility refers to a property of an object being flexible and bendable. In other words, it is a property of an object that can be deformed in response to an external force applied to the object, and elasticity or restorability to the former shape is not taken into consideration. A storage battery having flexibility, i.e., a flexible storage battery can be deformed in response to an external force. A flexible storage battery can be used with its shape fixed in a state of being deformed, can be used while repeatedly deformed, and can be used in a state of not deformed.

The descriptions in embodiments for the present invention can be combined with each other as appropriate.

### Embodiment 1

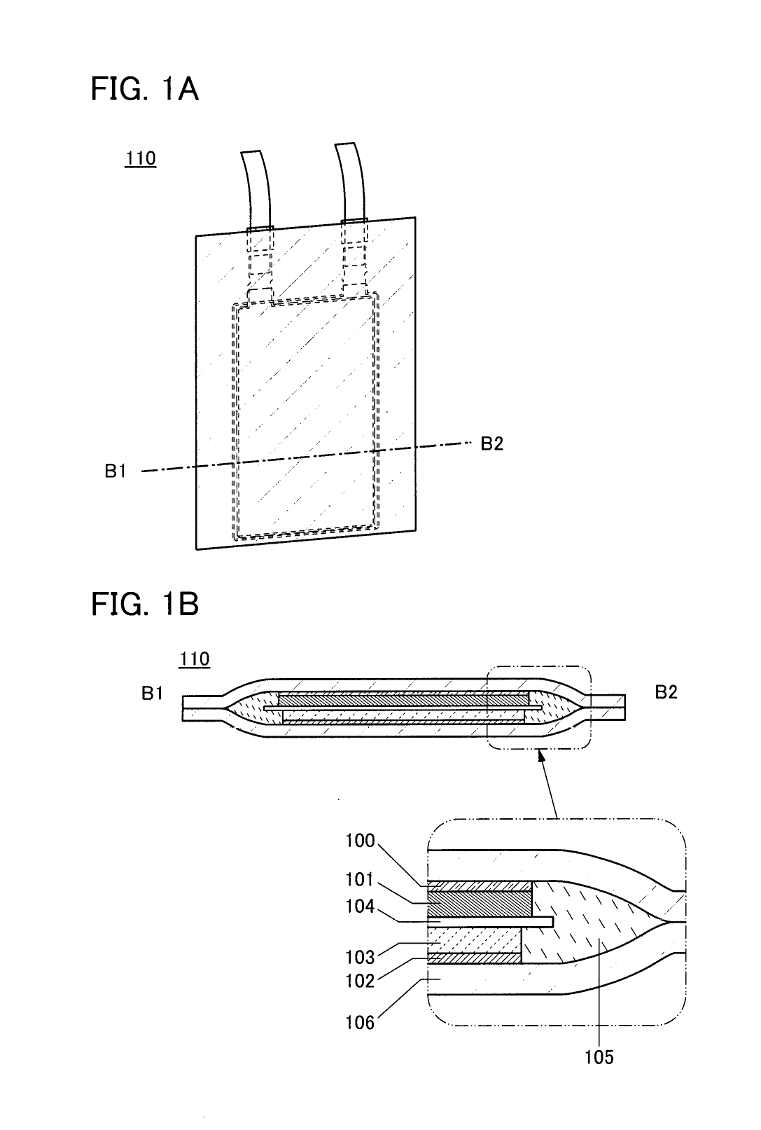

In this embodiment, a positive electrode used in a lithium-ion storage battery 110 of one embodiment of the present invention will be described with reference to FIGS. 1A and 1B. FIG. 1B is a cross-sectional view of the lithium-ion storage battery 110 taken along the dashed-dotted line B1-B2 in FIG. 1A. In the schematic cross-sectional view, a positive electrode current collector 100, a positive electrode active material layer 101, a separator 104, a negative electrode active material layer 103, and a negative electrode current collector 102 are stacked and, together with an electrolytic solution 105, enclosed by an exterior body 106. Note that the active material layers can be formed on both surfaces of the current collector, and the storage battery can have a stacked-layer structure.

### <<Structure of Positive Electrode>>

The positive electrode includes the positive electrode current collector 100 and the positive electrode active material layer 101.

A lithium-manganese-oxide-based material is known as a positive electrode active material used for a positive electrode active material layer. As is generally known, the physical property of a lithium-manganese-oxide-based material depends on the proportions of elements of manganese, oxygen, and lithium. First, a lithium-manganese composite oxide formed by combining LiMn_{2-A}M_{A}O₄, which is a lithium-manganese oxide, having a spinel crystal structure and Li₂Mn_{l-B}M_{B}O₃ having a layered rock-salt (α-NaFeO₂) crystal structure will be described. Note that M is a metal element other than lithium (Li) and manganese (Mn), or Si or P.

The lithium-manganese composite oxide has a spinel crystal structure in part of the surface of each particle with a layered rock-salt crystal structure. In the case of using the lithium-manganese composite oxide as a positive electrode active material of a lithium-ion storage battery, lithium inside the particle is released or diffused through the region with a spinel crystal structure of the surface of the particle, resulting in high capacity. Furthermore, the lithium-manganese composite oxide preferably includes a plurality of portions each having a spinel crystal structure such that each particle is dotted with them. Note that in each particle of the lithium-manganese composite oxide, a region having a layered rock-salt crystal structure is preferably larger than the regions each having a spinel crystal structure.

The lithium-manganese composite oxide is represented by LiₓMn_{y}M_{z}O_{w}, (M is a metal element other than lithium (Li) and manganese (Mn), or Si or P). In LiₓMn_{y}M_{z}O_{w}, the element represented by M is preferably a metal element selected from Ni, Ga, Fe, Mo, In, Nb, Nd, Co, Sm, Mg, Al, Ti, Cu, and Zn, or Si or P, and Ni is the most preferable. Note that M is not necessarily one kind of element and may be two or more kinds of elements.

A method for forming the lithium-manganese composite oxide represented by LiₓMn_{y}M_{z}O_{w} will be described in detail below. Here, Ni is used as the element M

As raw materials of the lithium-manganese composite oxide, Li₂CO₃, MnCO₃, and NiO can be used, for example.

First, each of the raw materials is weighed to have a desired molar ratio.

Next, acetone is added to the powder of these materials, and then, they are mixed in a ball mill to prepare mixed powder.

After that, heating is performed to volatilize acetone, so that a mixed material is obtained.

Then, the mixed material is put into a crucible, and is subjected to first firing at a temperature higher than or equal to 800° C. and lower than or equal to 1100° C. in the air for 5 to 20 hours inclusive to synthesis a novel material.

Subsequently, grinding is performed to separate the sintered particles. For the grinding, acetone is added and then mixing is performed in a ball mill.

After the grinding, heating is performed to volatilize acetone, and then, a solvent is evaporated in vacuum, so that a powdery novel material is obtained.

To increase the crystallinity or to stabilize the crystal, second firing may be performed after the first firing. The second firing is performed at a temperature higher than or equal to 500° C. and lower than or equal to 800° C., for example.

The second firing may be performed in a nitrogen atmosphere, for example.

Although Li₂CO₃, MnCO₃, and NiO are used as starting materials in this embodiment, the materials are not limited thereto and can be other materials.

When the ratio for weighing (also referred to as the ratio of raw materials) is changed, for example, a composite oxide with a layered rock-salt crystal structure and a spinel crystal structure can be obtained.

The ratio for weighing is the molar ratio between the raw materials used. For example, in the case where raw materials in which Li₂CO₃:MnCO₃:NiO=1:1.5:0.5 are used, the molar ratio of MnCO₃ to NiO is 3 (MnCO₃/NiO=1.5÷0.5). Note that the term “Ni/Mn (ratio of raw materials)” or “raw material ratio of Ni to Mn”, for example, explains the molar ratio of Ni to Mn among raw materials used. In the case where raw materials in which Li₂CO₃:MnCO₃:NiO=1:1.5:0.5 are used, for example, Li/Ni is 4 (Li/Mn=(1×2)÷0.5), whereas Mn/Ni is 3 (Mn/Ni=1.5÷0.5).

Here, the idea of changing the ratio for weighing is described.

In LiMn₂O₄ with a spinel structure, the atomic ratio of Li to Mn is 1:2, whereas in Li₂MnO₃ with a layered rock-salt structure, the atomic ratio of Li to Mn is 2:1. Thus, when the ratio of Mn to Li is made larger than ½, the proportion of the spinel structure can be increased, for example.

Here, a composite oxide including spinel crystallites at approximately 2% that is formed using Li₂CO₃ and MnCO₃ as starting materials is used for description. Note that the composite oxide including spinel crystallites at approximately 2% is equivalent to a composite oxide including layered rock-salt crystallites at approximately 98%.

The composite oxide including spinel crystallites at approximately 2% is formed in such a manner that Li₂CO₃ and MnCO₃ are weighed to have a ratio of 0.98:1.01 (Li₂CO₃:MnCO₃), pulverized in a ball mill or the like, and fired at a temperature higher than or equal to 800° C. and lower than or equal to 1100° C.

A composite oxide including spinel crystallites at approximately 5% is formed in such a manner that Li₂CO₃ and MnCO₃ are weighed so that the ratio of Li₂CO₃ to MnCO₃ is 0.955:1.03, and they are pulverized in a ball mill or the like and fired.

A composite oxide including spinel crystallites at approximately 50% is formed in such a manner that Li₂CO₃ and MnCO₃ are weighed so that the ratio of Li₂CO₃ to MnCO₃ is 0.64:1.28, and they are pulverized in a ball mill or the like and fired.

The above novel materials can be formed by intentionally changing the ratio of raw materials so that spinel crystallites are included at various proportions.

The above is the idea of changing the ratio for weighing.

Note that even when raw materials are weighed so that spinel crystallites are included at a predetermined proportion, the proportion of the spinel crystallites in an actually synthesized lithium-manganese composite oxide might be different from the predetermined proportion in some cases.

Note that although the case where Ni is not contained is described here for easy understanding, the same applies to the case where Ni is contained.

The ratio is changed to form a lithium-manganese composite oxide having a spinel crystal structure in part of the surface of each particle with a layered rock-salt crystal structure.

The lithium-manganese composite oxides obtained in the above manner exhibit various properties according to raw materials and compositions thereof.

For example, when a lithium-manganese composite oxide having a composition of Li₂Mn_{0.99}Ni_{0.01}O₃ as a lithium-manganese composite oxide containing Ni is used for a positive electrode active material, it serves as an active material that can have high capacity if the materials in the composite oxide and Li fully contribute to charge and discharge. The discharge capacity of the composite oxide is much higher than that of a mixture of LiMn₂O₄ and Li₂MnO₃.

Here, when the charge capacity of a lithium-manganese composite oxide used as a positive electrode active material for a storage battery is much higher than the discharge capacity thereof, the irreversible capacity is high and the capacity of a negative electrode active material also needs to be high; therefore, a large amount of negative electrode active material is needed. However, since the discharge capacity of the lithium-manganese composite oxide is much lower than the charge capacity thereof, the amount of the negative electrode active material that corresponds to the difference therebetween does not contribute to charge and discharge in the second and subsequent cycles. That is, the weight of the storage battery is increased and the capacity of the battery per weight is reduced.

In contrast, the discharge capacity of a lithium-manganese oxide used as a positive electrode active material is much higher than the charge capacity thereof depending on its composition. A spinel lithium-manganese oxide LiMn₂O₄ is one example thereof. When such a lithium-manganese oxide is used as a positive electrode active material of a lithium-ion storage battery, the discharge capacity over the charge capacity cannot be used for discharge; thus, high discharge capacity cannot be utilized and a positive electrode including the positive electrode active material cannot have high capacity.

In view of the above, in one embodiment of the present invention, the positive electrode active material layer 101 is formed in such a manner that a plurality of materials for a positive electrode active material are mixed to be used as the positive electrode active material; accordingly, a positive electrode with high capacity is obtained.

When the materials for the positive electrode active material are utilized without waste, the capacity per unit weight can be high. In order to utilize the materials for the positive electrode active material without waste, two or more kinds of materials for the positive electrode active material are mixed at a specific ratio so that charge capacity and discharge capacity can be close (preferably, equal) to each other.

For example, when two kinds of materials for the positive electrode active material are mixed, the charge capacity and the discharge capacity of a mixed positive electrode active material are expressed by Formula (2) and Formula (3) respectively, where one of the positive electrode active materials is an active material 1 and the other is an active material 2.

Q_{c1}R₁+Q_{c2}R₂ (2)

Q_{d1}R₁−Q_{d2}R₂ (3)

In the formulae, the charge capacity and the discharge capacity of the active material 1 are denoted by Q_{c1}and Q_{d1} respectively, the charge capacity and the discharge capacity of the active material 2 are denoted by Q_{c2} and Q_{d2} respectively, and the weight proportions of the active material 1 and the active material 2 in the mixed positive electrode active material are denoted by R₁ and R₂ respectively.

In order to utilize the mixed positive electrode active material without waste, the active material 1 and the active material 2 are mixed at a predetermined ratio such that the charge capacity and the discharge capacity of the mixed positive electrode active material agree with each other. That is, the mixture ratio satisfying Formula (4) is employed.

Q_{c1}R₁+Q_{c2}R₂32 Q_{d1}R₁+Q_{d2}R₂ (4)

Here, since the sum of R₁ and R₂ is 1, R₁ satisfying the above condition is expressed by Formula (1).

$${R}_{1} = \frac{( {Q}_{c 2} - {Q}_{d 2} )}{( {Q}_{c 2} - {Q}_{d 2} ) - ( {Q}_{c 1} - {Q}_{d 1} )} \qquad ( 1 )$$

Here, Q_{c1}, Q_{d1}, Q_{c2}, and Q_{d2} are each a positive value, and R₁ and R₂ are each larger than 0 and smaller than 1. If the charge capacity Q_{c2} of the active material 2 is higher than the discharge capacity Q_{d2}, the numerator of Formula (1) is a positive value, and the numerator of Formula (1) is larger than the denominator thereof when Q_{c1}-Q_{d1} is a positive value; there is a contradiction in this case because R₁ is over 1. This applies also to the case where the active material 1 and the active material 2 are interchanged with each other; therefore, in one embodiment of the present invention, the magnitude relation between the charge and discharge capacities of the active material 1 should be opposite to that between the charge and discharge capacities of the active material 2.

In the case where R₁ is smaller than the value calculated by Formula (1), the discharge capacity obtained by adding the discharge capacity of the active material 1 and the discharge capacity of the active material 2 together is higher than the charge capacity obtained by adding the charge capacity of the active material 1 and the charge capacity of the active material 2 together; thus, the negative electrode active material can be utilized without waste. According to one embodiment of the present invention, the difference between the charge and discharge capacities of the positive electrode active material is reduced; thus, the materials for the active material of the lithium-ion storage battery can be utilized without waste and the capacity per unit weight of the positive electrode can be increased.

Acetylene black (AB), graphite (black lead) particles, carbon nanotubes, graphene, fullerene, or the like can be used as a conductive additive of the electrode together with the active material.

A network for electrical conduction can be formed in the electrode by the conductive additive. The conductive additive also allows maintaining of a path for electrical conduction between the particles of the positive electrode active material. The addition of the conductive additive to the positive electrode active material layer increases the electrical conductivity of the positive electrode active material layer 101.

A typical example of the binder is polyvinylidene fluoride (PVDF), and other examples of the binder include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder in the positive electrode active material layer 101 is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the positive electrode active material layer 101 is preferably greater than or equal to 1 wt % and less than or equal to 10 wt %, more preferably greater than or equal to 1 wt % and less than or equal to 5 wt %.

In the case where the positive electrode active material layer 101 is formed by a coating method, the positive electrode active material, the binder, the conductive additive, and a dispersion medium are mixed to form electrode slurry, the electrode slurry is applied to the positive electrode current collector 100, and a solvent is evaporated. In this embodiment, a metal material containing aluminum as its main component is used as the positive electrode current collector 100.

The positive electrode current collector 100 can be formed using a material, which has high conductivity and is not alloyed with carrier ions of lithium or the like, such as stainless steel, gold, platinum, aluminum, or titanium, or an alloy thereof. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, and nickel. The positive electrode current collector can have a foil-like shape, a plate-like shape (sheet-like shape), a net-like shape, a punching-metal shape, an expanded-metal shape, or the like as appropriate.

Through the above steps, the positive electrode of the lithium-ion storage battery can be formed.

In Embodiment 1, one embodiment of the present invention has been described. Other embodiments of the present invention will be described in Embodiments 2 to 4. Note that one embodiment of the present invention is not limited thereto. In other words, various embodiments of the invention are described in this embodiment and the other embodiments, and one embodiment of the present invention is not limited to a particular embodiment. For example, although an example of use in a lithium-ion storage battery is described in this embodiment, one embodiment of the present invention is not limited thereto. Application to a variety of storage batteries such as a lead storage battery, a lithium-ion polymer storage battery, a nickel-hydrogen storage battery, a nickel-cadmium storage battery, a nickel-iron storage battery, a nickel-zinc storage battery, a silver oxide-zinc storage battery, a solid-state battery, and an air battery is also possible. Application to a variety of power storage devices such as a primary battery, a capacitor, and a lithium-ion capacitor is also possible. Depending on circumstances or conditions, one embodiment of the present invention is not necessarily applied to a lithium-ion storage battery, for example. Although an example where two or more kinds of materials are mixed to be used as a positive electrode active material has been described as one embodiment of the present invention, one embodiment of the present invention is not limited to this. Depending on circumstances or conditions, in one embodiment of the present invention, one kind of material may be used as a positive electrode active material. Furthermore, for example, depending on circumstances or conditions, in one embodiment of the present invention, the positive electrode active material layer does not necessarily include a plurality of kinds of positive electrode active materials.

This embodiment can be implemented in appropriate combination with any of the other embodiments and example.

### Embodiment 2

In this embodiment, the lithium-ion storage battery 110 including the positive electrode which is described in Embodiment 1 will be described with reference to FIGS. 1A and 1B. Components other than the positive electrode will be described below.

### <<Structure of Negative Electrode>>

A negative electrode will be described with reference to FIG. 1B. The negative electrode includes the negative electrode active material layer 103 and the negative electrode current collector 102. Steps for forming the negative electrode will be described below.

Examples of a carbon-based material as the negative electrode active material used for the negative electrode active material layer 103 include graphite, graphitizing carbon (soft carbon), non-graphitizing carbon (hard carbon), a carbon nanotube, graphene, and carbon black. Examples of the graphite include artificial graphite such as meso-carbon microbeads (MCMB), coke-based artificial graphite, or pitch-based artificial graphite and natural graphite such as spherical natural graphite. In addition, the shape of the graphite is a flaky shape or a spherical shape, for example.

In addition to the carbon-based materials, a material that enables charge-discharge reactions by an alloying reaction and a dealloying reaction with lithium can be used as the negative electrode active material. For example, a material containing at least one of Ga, Si, Al, Ge, Sn, Pb, Sb, Bi, Ag, Zn, Cd, In, and the like can be used. Such elements have higher capacity than carbon. In particular, silicon is preferred because it has a high theoretical capacity of 4200 mAh/g. Examples of an alloy-based material (compound-based material) using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, for the negative electrode active material, an oxide such as SiO, SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten dioxide (WO₂), or molybdenum dioxide (MoO₂) can be used.

Still alternatively, for the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

When a nitride containing lithium and a transition metal are used, lithium ions are contained in the negative electrode active material; thus, the negative electrode active material can be used in combination with a material for a positive electrode active material that does not contain lithium ions, such as V₂O₅ or Cr₃O₈. In the case of using a material containing lithium ions as a positive electrode active material, the nitride containing lithium and a transition metal can be used for the negative electrode active material by extracting the lithium ions contained in the positive electrode active material in advance.

Alternatively, a material which causes a conversion reaction can be used for the negative electrode active material. For example, a transition metal oxide with which an alloying reaction with lithium is not caused, such as cobalt oxide (CoO), nickel oxide (NiO), or iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

The particle diameter of the negative electrode active material is preferably greater than or equal to 50 nm and less than or equal to 100 μm, for example.

Note that it is acceptable that a plurality of materials for active materials are combined at a given proportion both for the positive electrode active material layer 101 and the negative electrode active material layer 103. The use of a plurality of materials for the active material layer makes it possible to select the performance of the active material layer in detail.

Examples of a conductive additive of an electrode include acetylene black (AB), graphite (black lead) particles, carbon nanotubes, graphene, and fullerene.

A network for electrical conduction can be formed in the electrode by the conductive additive. The conductive additive also allows maintaining of a path for electrical conduction between the particles of the negative electrode active material. The addition of the conductive additive to the negative electrode active material layer increases the electric conductivity of the negative electrode active material layer 103.

A typical example of the binder is polyvinylidene fluoride (PVDF), and other examples of the binder include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder in the negative electrode active material layer 103 is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the negative electrode active material layer 103 is preferably greater than or equal to 1 wt % and less than or equal to 10 wt %, more preferably greater than or equal to 1 wt % and less than or equal to 5 wt %.

The negative electrode active material layer 103 is formed over the negative electrode current collector 102. In the case where the negative electrode active material layer 103 is formed by a coating method, the negative electrode active material, the binder, the conductive additive, and a dispersion medium are mixed to form slurry, the slurry is applied to the negative electrode current collector 102, and a solvent is evaporated. If necessary, pressing may be performed after the solvent is evaporated.

The negative electrode current collector 102 can be formed using a material, which has high conductivity and is not alloyed with carrier ions of lithium or the like, such as stainless steel, gold, platinum, zinc, iron, copper, titanium, tantalum, or an alloy thereof. Alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, and nickel. The negative electrode current collector 102 can have a foil-like shape, a plate-like shape (sheet-like shape), a net-like shape, a cylindrical shape, a coil shape, a punching-metal shape, an expanded-metal shape, or the like as appropriate. The negative electrode current collector 102 preferably has a thickness greater than or equal to 5 μm and less than or equal to 30 μm. Part of the surface of the electrode current collector may be provided with an undercoat layer using graphite or the like.

Through the above steps, the negative electrode of the lithium-ion storage battery 110 can be formed.

### <Structure of Separator>

The separator 104 will be described below. The separator 104 may be formed using a material such as paper, nonwoven fabric, a glass fiber, a synthetic fiber such as nylon (polyamide), vinylon (a polyvinyl alcohol based fiber), polyester, acrylic, polyolefin, or polyurethane. Note that it is necessary to select a material which does not dissolve in an electrolytic solution described later.

More specifically, as a material for the separator 104, high-molecular compounds based on fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, nonwoven fabric, and a glass fiber can be used either alone or in combination.

The separator 104 needs to have insulation performance that prevents connection between the electrodes, performance that holds the electrolytic solution, and ionic conductivity. As a method for forming a film having a function as a separator, a method for forming a film by stretching is given. Examples of the method include a stretching aperture method in which a melted polymer material is spread, heat is released from the material, and pores are formed by stretching the resulting film in the directions of two axes parallel to the film.

To set the separator 104 in a storage battery, a method in which the separator is inserted between the positive electrode and the negative electrode can be used. Alternatively, a method in which the separator 104 is placed on one of the positive electrode and the negative electrode and then the other of the positive electrode and the negative electrode is placed thereon can be used. The positive electrode, the negative electrode, and the separator are stored in the exterior body, and the exterior body is filled with the electrolytic solution, whereby the storage battery can be formed.

The separator 104 with a size large enough to cover each surface of either the positive electrode or the negative electrode, in a form of sheet or envelope, may be fabricated to form the electrode wrapped in the separator 104. In that case, the electrode can be protected from mechanical damages in the manufacture of the storage battery and the handling of the electrode becomes easier. The electrode wrapped in the separator and the other electrode are stored in the exterior body, and the exterior body is filled with the electrolytic solution, whereby the storage battery can be formed. FIG. 1B shows a cross-sectional structure of a storage battery including the separator having an envelope-like shape. Although FIG. 1B shows the cross-sectional structure of the storage battery including a pair of the positive electrode and the negative electrode, a storage battery with a layered structure including a plurality of pairs of the positive electrode and the negative electrode may also be manufactured.

The separator 104 may be a plurality of layers. Although the separator 104 can be formed by the above method, the range of the thickness of the film and the size of the pore in the film of the separator 104 is limited by a material of the separator and mechanical strength of the film. A first separator and a second separator each formed by a stretching method may be used together in a storage battery. The first separator and the second separator can be formed using one or more kinds of materials selected from the above-described materials or materials other than those described above. Characteristics such as the size of the pore in the film, the proportion of the volume of the pores in the film (also referred to as porosity), and the thickness of the film can be determined by film formation conditions, film stretching conditions, and the like. By using the first separator and the second separator having different characteristics, the performance of the separators of the storage battery can be selected more variously than in the case of using one of the separators.

The storage battery may be flexible. In the case where flow stress is applied to the flexible storage battery, the stress can be relieved by sliding of the first separator and the second separator at the interface between the first separator and the second separator. Therefore, the structure including a plurality of separators is also suitable as a structure of a separator in a flexible storage battery.

Through the above steps, the separator can be incorporated in the lithium-ion storage battery 110.

### <Components of Electrolytic Solution>

The electrolytic solution 105 used in the lithium-ion storage battery of one embodiment of the present invention is preferably a nonaqueous solution containing an electrolyte.

For a solvent of the electrolytic solution 105, a material in which carrier ions can transfer is used. For example, an aprotic organic solvent is preferably used, and one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When a gelled polymer material is used as the solvent of the electrolytic solution 105, safety against liquid leakage and the like is improved. Furthermore, the lithium-ion storage battery can be thinner and more lightweight. Typical examples of the gelled high-molecular material include a silicone gel, an acrylic gel, an acrylonitrile gel, a polyethylene oxide-based gel, a polypropylene oxide-based gel, and a fluorine-based polymer gel.

Alternatively, the use of one or more kinds of ionic liquids (room temperature molten salts) that have non-flammability and non-volatility as the solvent for the electrolytic solution can prevent a lithium-ion storage battery from exploding or catching fire even when the lithium-ion storage battery internally shorts out or the internal temperature increases due to overcharging or the like. Thus, the lithium-ion storage battery has improved safety.

Examples of an electrolyte dissolved in the above-described solvent are one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂, or two or more of these lithium salts in an appropriate combination in an appropriate ratio.

In the storage battery, when a metal included in the positive electrode active material is dissolved by reaction between the electrolytic solution and the active material, the capacity of the storage battery is decreased and the storage battery deteriorates. That is, the capacity is significantly decreased as charging and discharging are repeated through the cycle life test of the storage battery, and the lifetime of the storage battery becomes short. In one embodiment of the present invention, the use of a material which is less likely to react with the active material for the electrolyte material included in the electrolytic solution makes it less likely to cause the dissolution of the metal in the active material.

Examples of the metal in the materials for the positive electrode active material include Fe, Co, Ni, and Mn. In one embodiment of the present invention, for the electrolyte material used for the electrolytic solution, an electrolyte which is less likely to dissolve these metals included in the positive electrode active material layer 101 may be used. Specifically, LiTFSA (lithium bis(trifluoromethanesulfonyl)amide) or LiFSA (lithium bis(fluorosulfonyl)amide) can be used. Note that LiTFSA includes Li, N, a trifluoromethyl group, and a sulfonyl group. That is, LiTFSA includes Li, N, F, S, O, and C. LiFSA includes Li, N, F, and a sulfonyl group. That is, LiFSA includes Li, N, F, S, and O.

The electrolytic solution using LiTFSA or LiFSA as the electrolyte inhibits the metal included in the material for the positive electrode active material from dissolving in battery reaction of the storage battery. Therefore, for example, an XPS (X-ray photoelectron spectroscopy) analysis performed on a surface of the negative electrode, which is taken out of the storage battery disassembled after charge and discharge are repeatedly performed, shows that the metal is not observed or the amount of the metal is extremely small.

Therefore, the dissolution of the metal included in the positive electrode active material into the electrolytic solution is inhibited, so that the deterioration of the positive electrode active material is inhibited. In addition, the deposition of the metal on a surface of the negative electrode is inhibited, so that the capacity reduction is small, and the storage battery can have a preferable cycle lifetime.

Although the case where carrier ions are lithium ions in the above electrolyte is described, carrier ions other than lithium ions can be used. Examples of carrier ions which can be used instead of lithium ions are alkali metal ions such as sodium ions and potassium ions; alkaline-earth metal ions such as calcium ions, strontium ions, barium ions, beryllium ions, and magnesium ions. In that case, instead of lithium in the above lithium salts, an alkali metal (e.g., sodium or potassium), an alkaline-earth metal (e.g., calcium, strontium, barium, beryllium, or magnesium) may be used for the electrolyte.

The electrolytic solution used for the storage battery is preferably a highly purified one so as to contain a negligible amount of dust particles and elements other than the constituent elements of the electrolytic solution (hereinafter, also simply referred to as impurities). Specifically, the mass ratio of impurities to the electrolytic solution is less than or equal to 1%, preferably less than or equal to 0.1%, and more preferably less than or equal to 0.01%. An additive agent such as vinylene carbonate may be added to the electrolytic solution.

Note that the electrolytic solution in which LiTFSA or LiFSA is used for the electrolyte reacts with and corrodes the positive electrode current collector in some cases when the positive electrode voltage is high. In order to prevent such corrosion, several weight percent of LiPF₆ is preferably added to the electrolytic solution, in which case a passive film is formed on a surface of the positive electrode current collector and prevents reaction between the electrolytic solution and the positive electrode current collector. Note that the concentration of LiPF₆ is less than or equal to 10 wt %, preferably less than or equal to 5 wt %, and further preferably less than or equal to 3 wt % in order that the positive electrode active material layer is not dissolved.

### <Structure of Exterior Body>

Next, the exterior body 106 will be described. As the exterior body 106, a film having a three-layer structure can be used, for example. In the three-layer structure, a highly flexible metal thin film of, for example, aluminum, stainless steel, copper, or nickel is provided over a film formed of a material such as polyethylene, polypropylene, polycarbonate, ionomer, or polyamide, and an insulating synthetic resin film of, for example, a polyamide-based resin or a polyester-based resin is provided as the outer surface of the exterior body over the metal thin film. With such a three-layer structure, permeation of an electrolytic solution and a gas can be blocked and an insulating property and resistance to the electrolytic solution can be obtained. The exterior body is folded inside in two, or two exterior bodies are stacked with the inner surfaces facing each other, in which case application of heat melts the materials on the overlapping inner surfaces to cause fusion bonding between the two exterior bodies. In this manner, a sealing structure can be formed.

A portion where the sealing structure is formed by fusion bonding or the like of the exterior body is referred to as a sealing portion. In the case where the exterior body is folded inside in two, the sealing portion is formed in the place other than the fold, and a first region of the exterior body and a second region of the exterior body that overlaps with the first region are fusion-bonded, for example. In the case where two exterior bodies are stacked, the sealing portion is formed along the entire circumference by heat fusion bonding or the like.

When a flexible material is selected from materials of the members described in this embodiment and used, a flexible lithium-ion storage battery can be manufactured. Deformable devices are currently under active research and development. For such devices, flexible storage batteries are demanded.

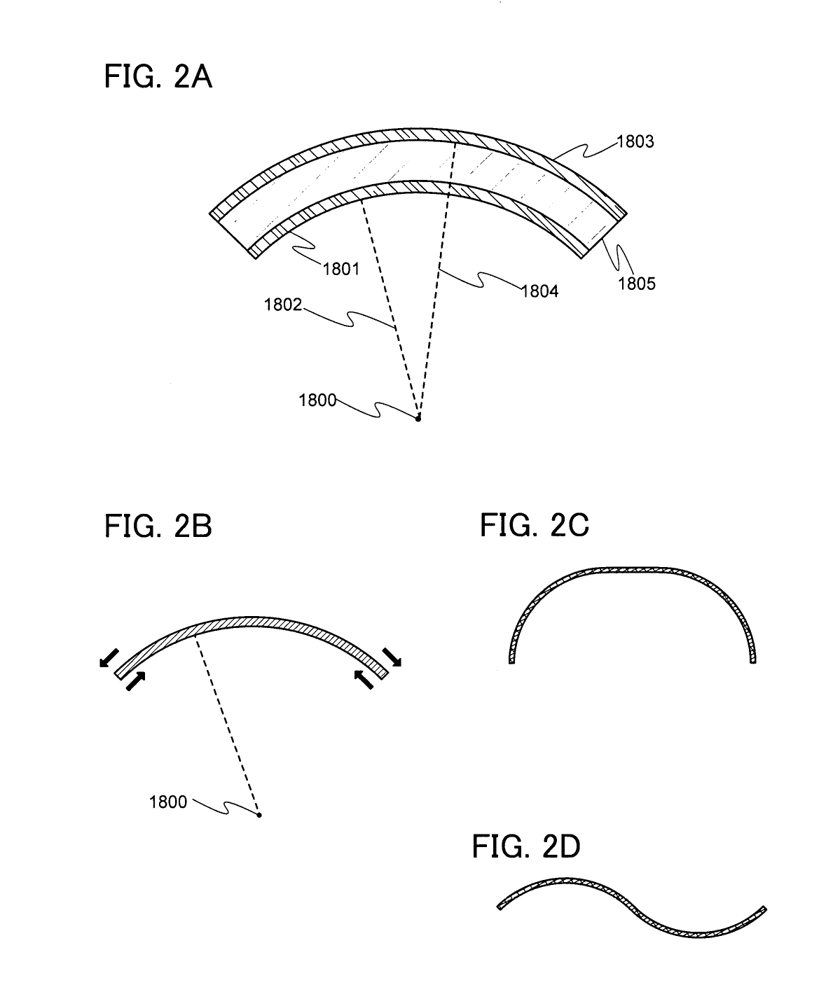

In the case of bending a storage battery in which a component 1805 including electrodes and an electrolytic solution is sandwiched between two films as exterior bodies, a radius 1802 of curvature of a film 1801 closer to a center 1800 of curvature of the storage battery is smaller than a radius 1804 of curvature of a film 1803 farther from the center 1800 of curvature (FIG. 2A). When the storage battery is curved and has an arc-shaped cross section, compressive stress is applied to a surface of the film on the side closer to the center 1800 of curvature and tensile stress is applied to a surface of the film on the side farther from the center 1800 of curvature (FIG. 2B).

When a flexible lithium-ion storage battery is deformed, strong stress is applied to the exterior bodies. However, even with the compressive stress and tensile stress due to the deformation of the storage battery, the influence of a strain can be reduced by forming a pattern including projections or depressions on surfaces of the exterior bodies. For this reason, the storage battery can change its form in such a range that the exterior body on the side closer to the center of curvature has a radius of curvature of 30 mm, preferably 10 mm.

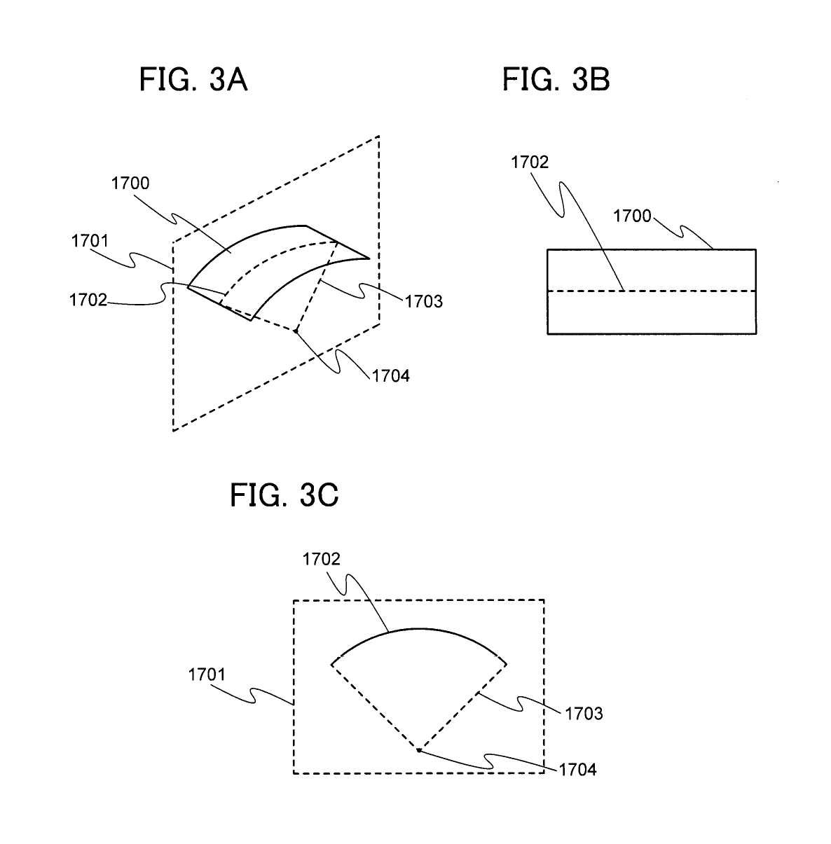

The radius of curvature of a surface will be described with reference to FIGS. 3A to 3C. In FIG. 3A, on a plane 1701 along which a curved surface 1700 is cut, part of a curve 1702 forming the curved surface 1700, is approximate to an arc of a circle; the radius of the circle is referred to as a radius 1703 of curvature and the center of the circle is referred to as a center 1704 of curvature. FIG. 3B is a top view of the curved surface 1700. FIG. 3C is a cross-sectional view of the curved surface 1700 taken along the plane 1701. When a curved surface is cut by a plane, the radius of curvature of a curve in a cross section differs depending on the angle between the curved surface and the plane or on the cut position, and the smallest radius of curvature is defined as the radius of curvature of a surface in this specification and the like.

Note that the cross-sectional shape of the storage battery is not limited to a simple arc shape, and the cross section can be partly arc-shaped; for example, a shape illustrated in FIG. 2C, a wavy shape illustrated in FIG. 2D, or an S shape can be used. When the curved surface of the storage battery has a shape with a plurality of centers of curvature, the storage battery can change its form in such a range that a curved surface with the smallest radius of curvature among radii of curvature with respect to the plurality of centers of curvature, which is a surface of the exterior body on the side closer to the center of curvature, has a curvature radius of 30 mm, preferably 10 mm.

This embodiment can be implemented in appropriate combination with any of the other embodiments and example.

### Embodiment 3

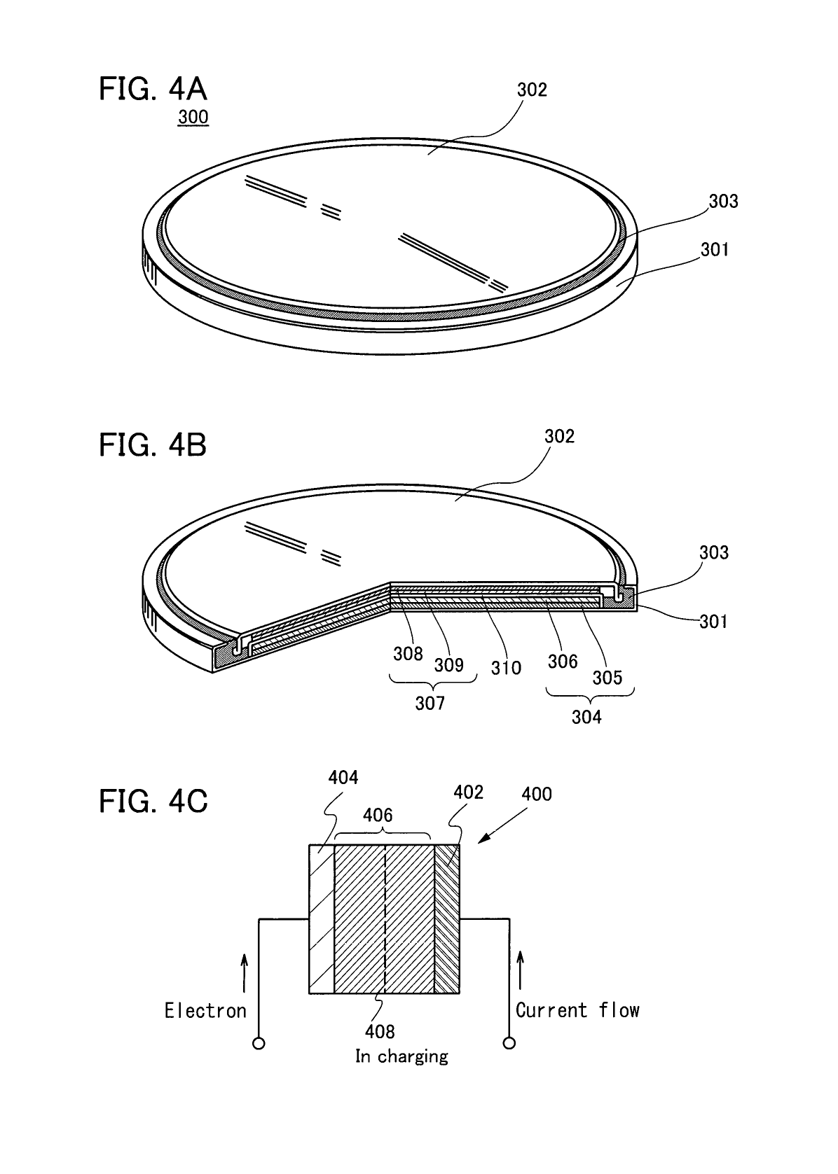

In this embodiment, structures of a storage battery of one embodiment of the present invention will be described with reference to FIGS. 4A to 4C, FIGS. 5A and 5B, and FIGS. 6A and 6B.

### [Coin-Type Storage Battery]

FIG. 4A is an external view of a coin-type (single-layer flat type) storage battery, and FIG. 4B is a cross-sectional view thereof.

In a coin-type storage battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. The positive electrode active material layer 306 may further include a binder for increasing adhesion of positive electrode active materials, a conductive additive for increasing the conductivity of the positive electrode active material layer, and the like in addition to the positive electrode active materials.

A negative electrode 307 includes a negative electrode current collector 308 and a negative electrode active material layer 309 provided in contact with the negative electrode current collector 308. The negative electrode active material layer 309 may further include a binder for increasing adhesion of negative electrode active materials, a conductive additive for increasing the conductivity of the negative electrode active material layer, and the like in addition to the negative electrode active materials. A separator 310 and an electrolyte (not illustrated) are provided between the positive electrode active material layer 306 and the negative electrode active material layer 309.

The materials described in Embodiment 1 or 2 can be used for the components.

For the positive electrode can 301 and the negative electrode can 302, a metal having a corrosion-resistant property to an electrolytic solution, such as nickel, aluminum, or titanium, an alloy of such a metal, or an alloy of such a metal and another metal (e.g., stainless steel or the like) can be used. Alternatively, the positive electrode can 301 and the negative electrode can 302 are preferably covered with nickel, aluminum, or the like in order to prevent corrosion due to the electrolytic solution. The positive electrode can 301 and the negative electrode can 302 are electrically connected to the positive electrode 304 and the negative electrode 307, respectively.

The negative electrode 307, the positive electrode 304, and the separator 310 are immersed in the electrolytic solution. Then, as illustrated in FIG. 4B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type storage battery 300 can be manufactured.

Here, a current flow in charging a storage battery will be described with reference to FIG. 4C. When a storage battery using lithium is regarded as a closed circuit, lithium ions transfer and a current flows in the same direction. Note that in the storage battery using lithium, an anode and a cathode change places in charge and discharge, and an oxidation reaction and a reduction reaction occur on the corresponding sides; hence, an electrode with a high redox potential is called a positive electrode and an electrode with a low redox potential is called a negative electrode. For this reason, in this specification, the positive electrode is referred to as a “positive electrode” and the negative electrode is referred to as a “negative electrode” in all the cases where charge is performed, discharge is performed, a reverse pulse current is supplied, and a charging current is supplied. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the term “anode” or “cathode” is used, whether it is at the time of charging or discharging is noted and whether it corresponds to a positive electrode or a negative electrode is also noted.

A storage battery 400 in FIG. 4C includes a positive electrode 402, a negative electrode 404, an electrolytic solution 406, and a separator 408. Two terminals connected to the positive electrode 402 and the negative electrode 404 are connected to a charger, and the storage battery 400 is charged. As the charge of the storage battery 400 proceeds, a potential difference between electrodes increases. The positive direction in FIG. 4C is the direction in which a current flows from one terminal outside the storage battery 400 to the positive electrode 402, flows from the positive electrode 402 to the negative electrode 404 in the storage battery 400, and flows from the negative electrode 404 to the other terminal outside the storage battery 400. In other words, a current flows in the direction of a flow of a charging current.

### [Cylindrical Storage Battery]

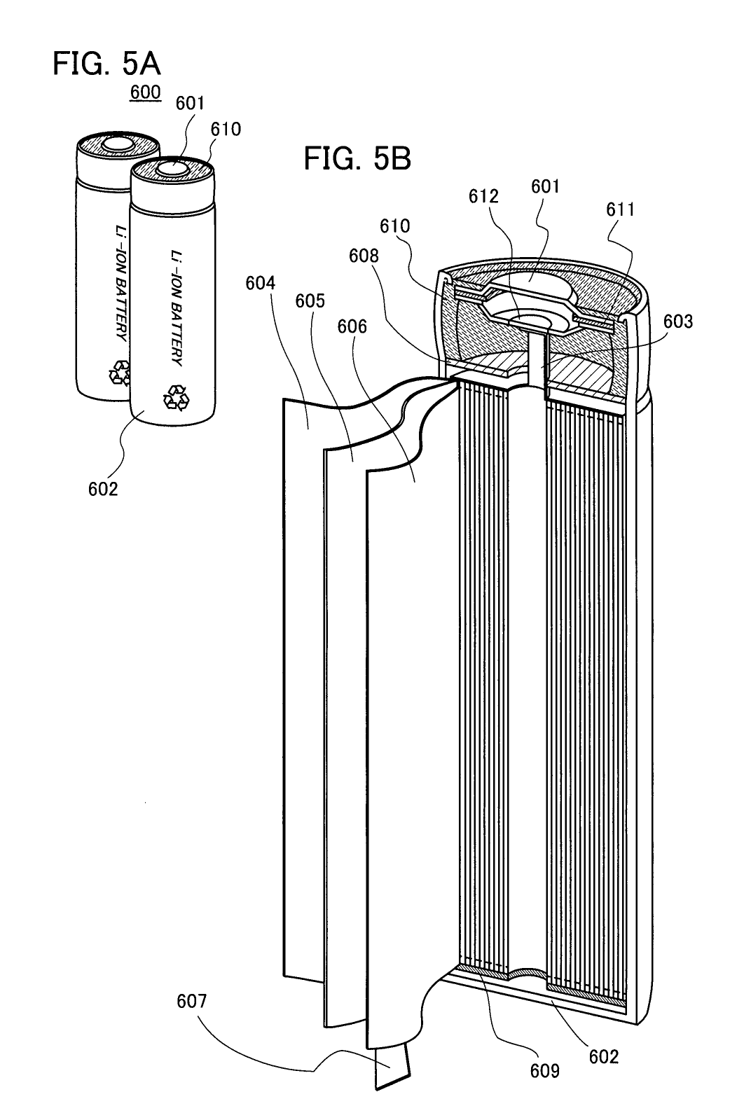

Next, an example of a cylindrical storage battery will be described with reference to FIGS. 5A and 5B. As illustrated in FIG. 5A, a cylindrical storage battery 600 includes a positive electrode cap (battery cap) 601 on the top surface and a battery can (outer can) 602 on the side surface and bottom surface. The positive electrode cap 601 and the battery can 602 are insulated from each other by a gasket (insulating gasket) 610.

FIG. 5B schematically illustrates a cross section of the cylindrical storage battery. Inside the battery can 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. One end of the battery can 602 is close and the other end thereof is open. For the battery can 602, a metal having a corrosion-resistant property to an electrolytic solution, such as nickel, aluminum, or titanium, an alloy of such metals, or an alloy of such a metal and another metal (e.g., stainless steel) can be used. Alternatively, the battery can 602 is preferably covered with nickel, aluminum, or the like in order to prevent corrosion due to the electrolytic solution. Inside the battery can 602, the battery element in which the positive electrode, the negative electrode, and the separator are wound is interposed between a pair of insulating plates 608 and 609 which face each other. Further, a nonaqueous electrolytic solution (not illustrated) is injected inside the battery can 602 provided with the battery element. As the nonaqueous electrolytic solution, a nonaqueous electrolytic solution which is similar to that of the above coin-type storage battery can be used.

Although the positive electrode 604 and the negative electrode 606 can be formed in a manner similar to that of the positive electrode and the negative electrode of the coin-type storage battery described above, the difference lies in that, since the positive electrode and the negative electrode of the cylindrical storage battery are wound, active materials are formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. Further, the PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic or the like can be used for the PTC element 611.

### [Laminated Storage Battery]

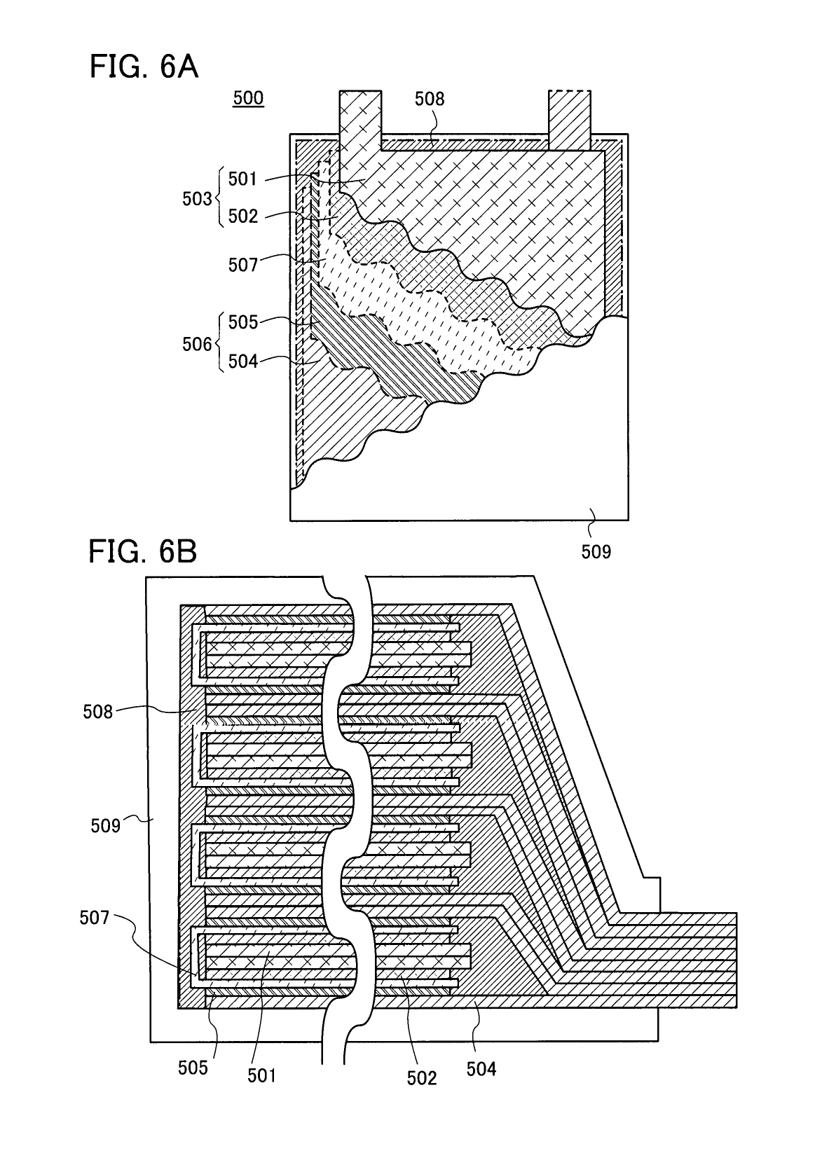

Next, an example of a laminated storage battery will be described with reference to FIG. 6A. When a flexible laminated storage battery is used in an electronic device at least part of which is flexible, the storage battery can be bent as the electronic device is bent.

A laminated storage battery 500 illustrated in FIG. 6A includes a positive electrode 503 including a positive electrode current collector 501 and a positive electrode active material layer 502, a negative electrode 506 including a negative electrode current collector 504 and a negative electrode active material layer 505, a separator 507, an electrolytic solution 508, and an exterior body 509. The separator 507 is provided between the positive electrode 503 and the negative electrode 506 in the exterior body 509. The exterior body 509 is filled with the electrolytic solution 508. The electrolytic solution described in Embodiment 1 or 2 can be used as the electrolytic solution 508.

In the laminated storage battery 500 illustrated in FIG. 6A, the positive electrode current collector 501 and the negative electrode current collector 504 also serve as terminals for an electrical contact with an external portion. For this reason, each of the positive electrode current collector 501 and the negative electrode current collector 504 may be arranged so that part of the positive electrode current collector 501 and part of the negative electrode current collector 504 are exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 in the laminated storage battery 500, for example, a laminate film having a three-layer structure where a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

FIG. 6B illustrates an example of a cross-sectional structure of the laminated storage battery 500. Although FIG. 6A illustrates an example of including only two current collectors for simplicity, the actual battery includes more electrode layers.

The example in FIG. 6B includes 16 electrode layers. The laminated storage battery 500 has flexibility even though including 16 electrode layers. The structure shown in FIG. 6B includes eight layers of negative current collectors 504 and eight layers of positive electrode current collectors 501, i.e., 16 layers in total. Note that in a cross-section of a negative electrode extraction portion illustrated in FIG. 6B, the eight layers of negative electrode current collectors 504 are bonded by ultrasonic welding. It is needless to say that the number of electrode layers is not limited to 16, and may be more than 16 or less than 16. In the case of using a large number of electrode layers, the storage battery can have high capacity. In contrast, in the case of using a small number of electrode layers, the storage battery can have a small thickness and high flexibility.

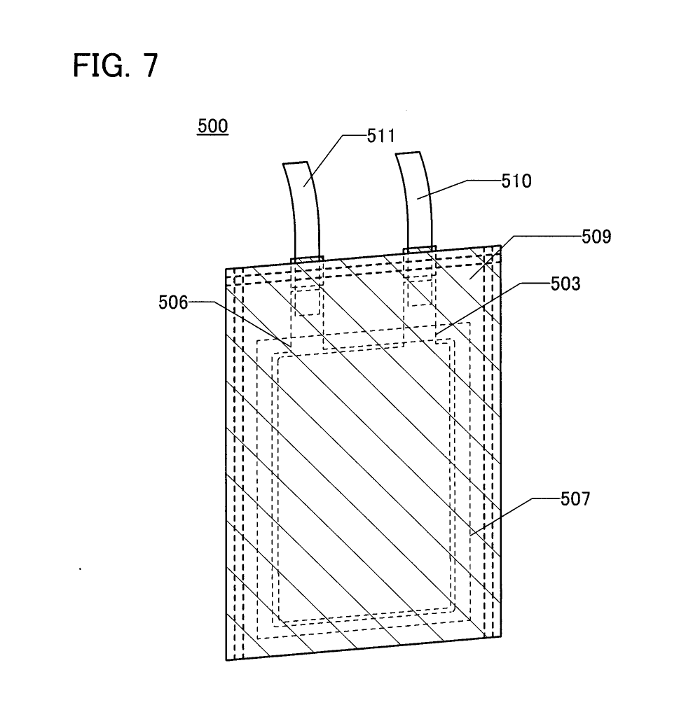

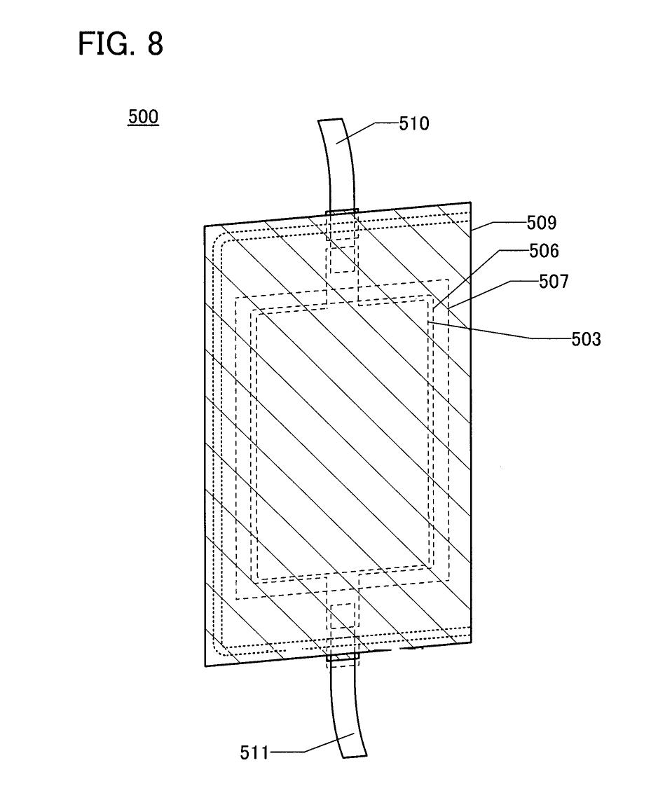

FIGS. 7 and 8 each illustrate an example of the external view of the laminated storage battery 500. In FIG. 7 and FIG. 8, the positive electrode 503, the negative electrode 506, the separator 507, the exterior body 509, a positive electrode lead electrode 510, and a negative electrode lead electrode 511 are included.

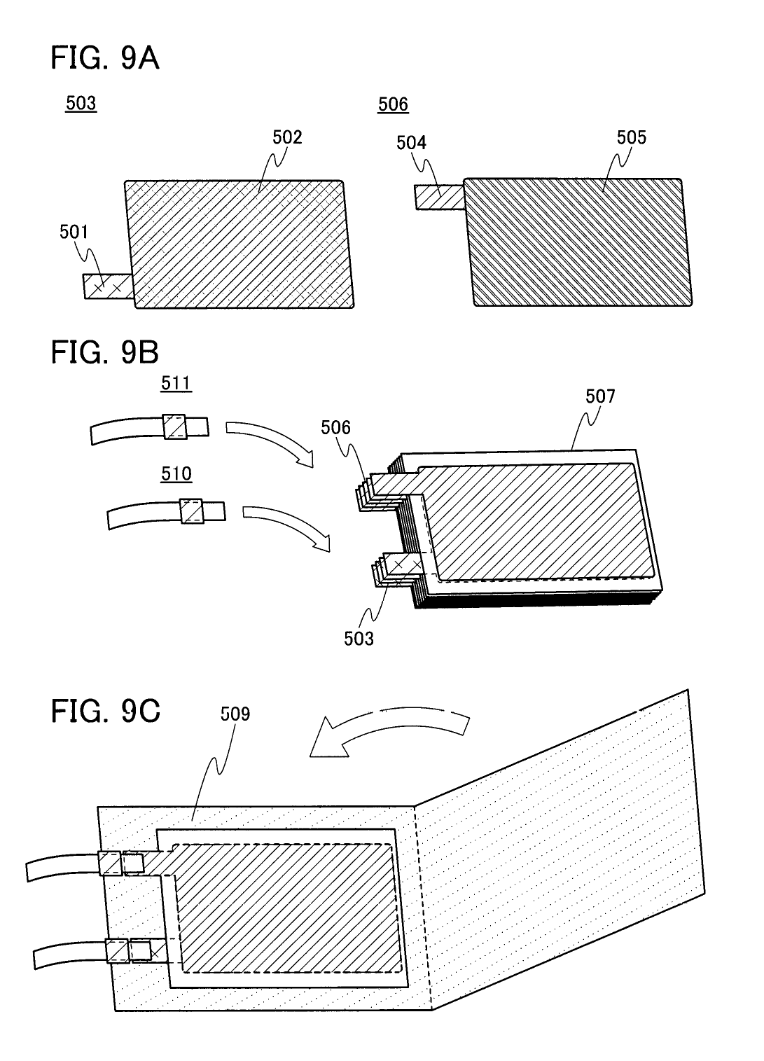

FIG. 9A shows external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter also referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and shapes of the tab regions included in the positive electrode and negative electrode are not limited to those illustrated in FIG. 9A.

### [Method for Manufacturing Laminated Storage Battery]

Here, an example of a method for manufacturing the laminated storage battery whose external view is illustrated in FIG. 7 will be described with reference to FIGS. 9B and 9C.

First, the negative electrode 506, the separator 507, and the positive electrode 503 are stacked. FIG. 9B illustrates a stack including the negative electrode 506, the separator 507, and the positive electrode 503. The battery described here as an example includes five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In addition, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a dashed line as illustrated in FIG. 9C. Then, the outer edge of the exterior body 509 is bonded. The bonding can be performed by thermocompression, for example. At this time, part (or one side) of the exterior body 509 is left unbonded (to provide an inlet) so that the electrolytic solution 508 can be introduced later.

Next, the electrolytic solution 508 is introduced into the exterior body 509 from the inlet of the exterior body 509. The electrolytic solution 508 is preferably introduced in a reduced pressure atmosphere or in an inert gas atmosphere. Lastly, the inlet is bonded. In the above manner, the laminated storage battery 500 can be manufactured.

Note that in this embodiment, the coin-type storage battery, the laminated storage battery, and the cylindrical storage battery are given as examples of the storage battery; however, any of storage batteries with a variety of shapes, such as a sealed storage battery and a square-type storage battery, can be used. Further, a structure in which a plurality of positive electrodes, a plurality of negative electrodes, and a plurality of separators are stacked or wound may be employed.

For each of the positive electrode active material layers of the storage batteries 300, 500, and 600, which are described in this embodiment, the positive electrode active material layer of one embodiment of the present invention is used. Thus, the capacity per unit weight of each of the storage batteries 300, 500, and 600 can be high.

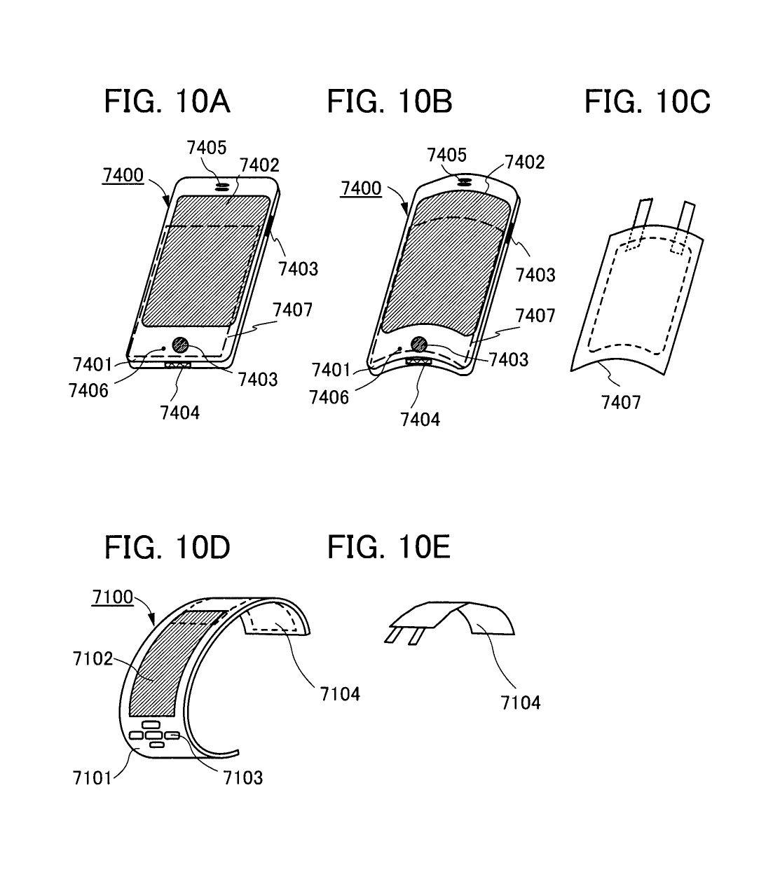

FIGS. 10A to 10E illustrate examples of an electronic device including a flexible laminated storage battery. Examples of an electronic device including a flexible power storage device include a television device (also referred to as a television or a television receiver), a monitor of a computer or the like, a camera such as a digital camera or a digital video camera, a digital photo frame, a mobile phone (also referred to as a cellular phone or a mobile phone device), a portable game machine, a portable information terminal, an audio reproducing device, and a large-sized game machine such as a pachinko machine.

In addition, a flexible power storage device can be incorporated along a curved inside/outside wall surface of a house or a building or a curved interior/exterior surface of a car.

FIG. 10A illustrates an example of a mobile phone. A mobile phone 7400 includes a display portion 7402 incorporated in a housing 7401, operation buttons 7403, an external connection port 7404, a speaker 7405, a microphone 7406, and the like. Note that the mobile phone 7400 includes a power storage device 7407.

FIG. 10B illustrates the mobile phone 7400 that is bent. When the whole mobile phone 7400 is bent by the external force, the power storage device 7407 included in the mobile phone 7400 is also bent. FIG. 10C illustrates the bent power storage device 7407. The power storage device 7407 is a laminated storage battery.

FIG. 10D illustrates an example of a bangle display device. A portable display device 7100 includes a housing 7101, a display portion 7102, operation buttons 7103, and a power storage device 7104. FIG. 10E illustrates the bent power storage device 7104.

### MODIFICATION EXAMPLE 1 OF STORAGE BATTERY

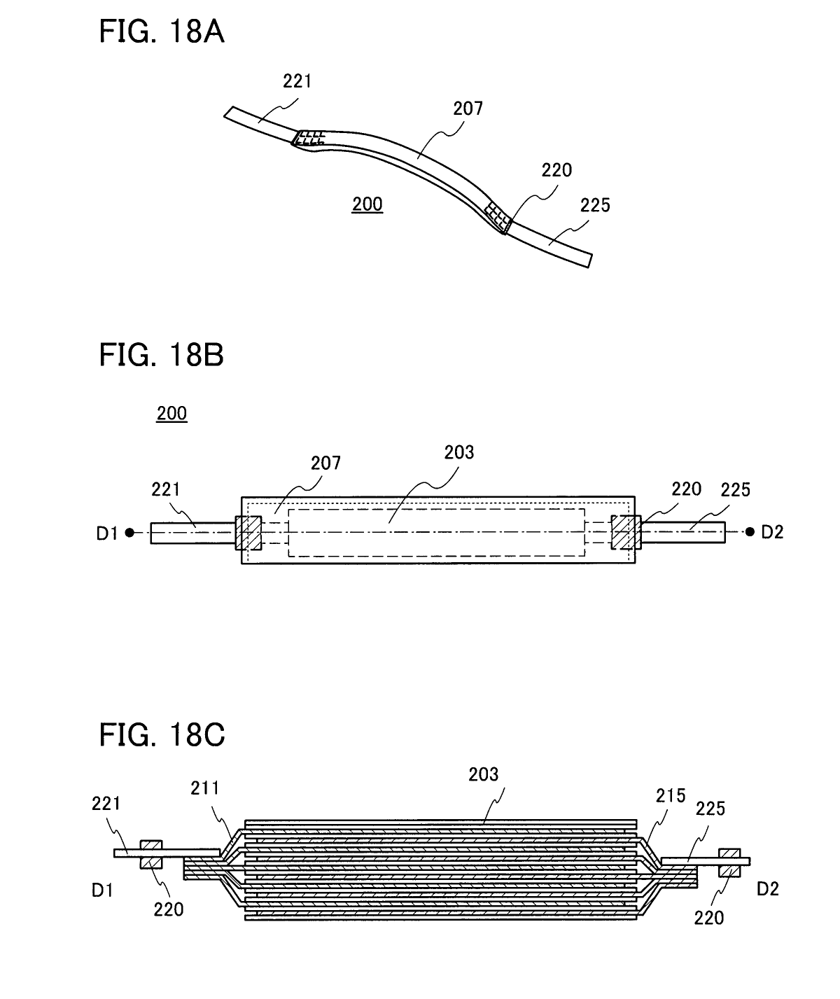

FIGS. 18A to 18C illustrate a storage battery 200, which is different from the storage battery illustrated in FIGS. 1A and 1B. FIG. 18A is a perspective view of the storage battery 200, and FIG. 18B is a top view thereof. FIG. 18C is a cross-sectional view taken along the dashed-dotted line D1-D2 in FIG. 18B. In FIG. 18C, a positive electrode 211, a negative electrode 215, a separator 203, a positive electrode lead 221, a negative electrode lead 225, and a sealing layer 220 are selectively illustrated for the sake of clarity.

The storage battery 200 illustrated in FIGS. 18A to 18C is different from the lithium-ion storage battery 110 illustrated in FIGS. 1A and 1B in the positions of the positive electrode lead 221 and the negative electrode lead 225 and the shapes of the positive electrode 211, the negative electrode 215, and the separator 203.

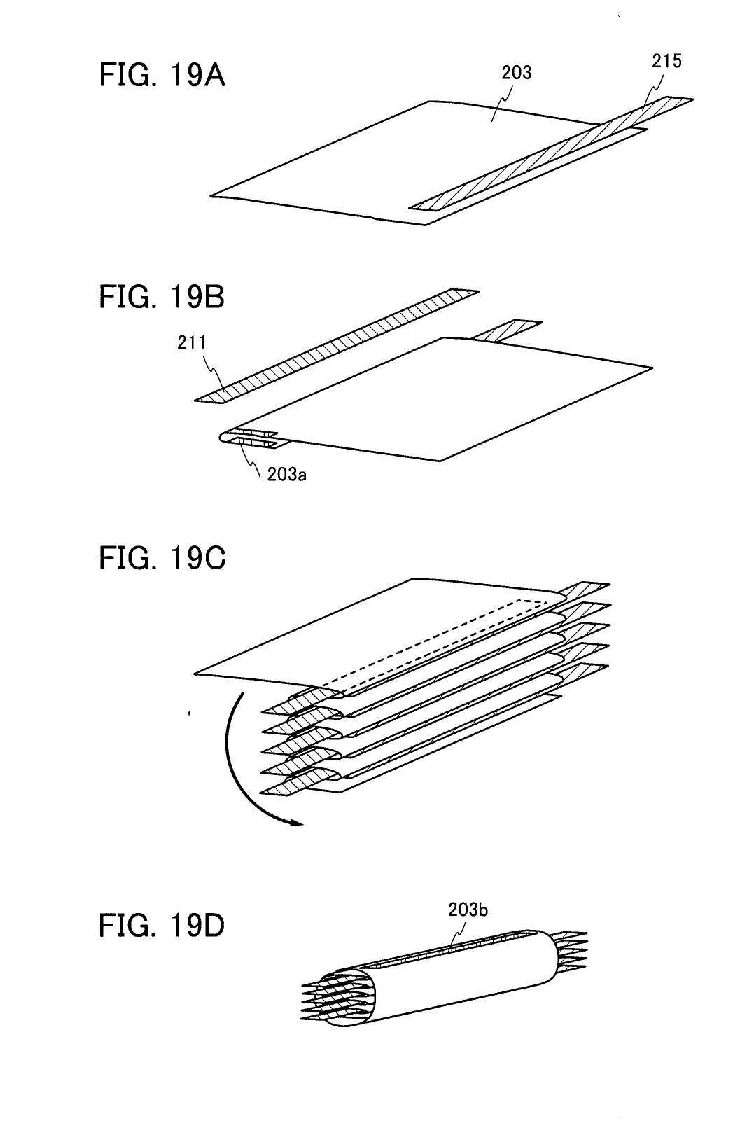

Here, some steps in the method for manufacturing the storage battery 200 illustrated in FIGS. 18A to 18C will be described with reference to FIGS. 19A to 19D.

First, the negative electrode 215 is positioned over the separator 203 (FIG. 19A) such that a negative electrode active material layer in the negative electrode 215 overlaps with the separator 203.

Then, the separator 203 is folded such that part of the separator 203 is positioned over the negative electrode 215. Next, the positive electrode 211 is positioned over the separator 203 (FIG. 19B) such that a positive electrode active material layer included in the positive electrode 211 overlaps with the separator 203 and the negative electrode active material layer. In the case where an electrode in which an active material layer is formed on one surface of a current collector is used, the positive electrode active material layer of the positive electrode 211 and the negative electrode active material layer of the negative electrode 215 are positioned so as to face each other with the separator 203 therebetween.

In the case where the separator 203 is formed using a material that can be thermally welded, such as polypropylene, a region where the separator 203 overlap with itself is thermally welded and then another electrode is positioned so as to overlap with the separator 203, whereby the slippage of the electrode in the fabrication process can be minimized. Specifically, a region which does not overlap with the negative electrode 215 or the positive electrode 211 and in which the separator 203 overlaps with itself, e.g., a region 203a in FIG. 19B, is preferably thermally welded.

By repeating the above steps, the positive electrode 211 and the negative electrode 215 can overlap with each other with the separator 203 therebetween as illustrated in FIG. 19C.

Note that a plurality of positive electrodes 211 and a plurality of negative electrodes 215 may be placed to be alternately sandwiched by the separator 203 that is repeatedly folded in advance.

Next, as illustrated in FIG. 19C, the plurality of positive electrodes 211 and the plurality of negative electrodes 215 are covered with the separator 203.

Then, as illustrated in FIG. 19D, a region where the separator 203 overlaps with itself, e.g., a region 203b in FIG. 19D, is thermally welded, and the plurality of positive electrodes 211 and the plurality of negative electrodes 215 are covered with the separator 203 to be bound.

Note that the plurality of positive electrodes 211, the plurality of negative electrodes 215, and the separator 203 may be bound with a binding material.

Since the positive electrodes 211 and the negative electrodes 215 are stacked through the above steps, one separator 203 has regions sandwiched between the plurality of positive electrodes 211 and the plurality of negative electrodes 215 and regions positioned so as to cover the plurality of positive electrodes 211 and the plurality of negative electrodes 215.

In other words, the separator 203 included in the storage battery 200 illustrated in FIGS. 18A to 18C is a single separator which is partly folded. In the folded parts of the separator 203, the plurality of positive electrodes 211 and the plurality of negative electrodes 215 are provided.

The description in Embodiments 1 and 2 can be referred to for structures of the storage battery 200 other than bonding regions of an exterior body 207, the shapes of the positive electrodes 211, the negative electrodes 215, the separator 203, and the exterior body 207, and the positions and shapes of the positive electrode lead 221 and the negative electrode lead 225. The manufacturing method described in Embodiments 1 and 2 can be referred to for the steps other than the steps of stacking the positive electrodes 211 and the negative electrodes 215 in the manufacturing method of the storage battery 200.

### MODIFICATION EXAMPLE 2 OF STORAGE BATTERY

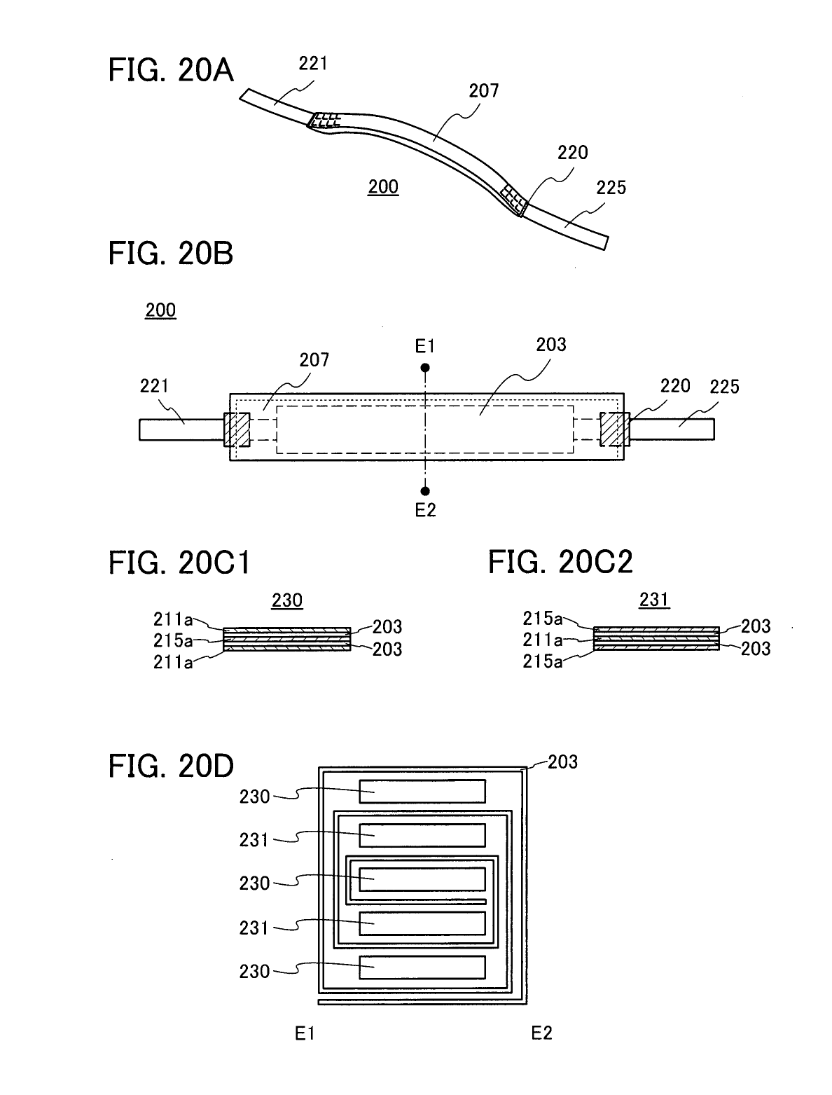

FIGS. 20A, 20B, 20C1, 20C2, and 20D illustrate the storage battery 200, which is different from the storage battery illustrated in FIGS. 1A and 1B. FIG. 20A is a perspective view of the storage battery 200, and FIG. 20B is a top view thereof. FIG. 20C1 is a cross-sectional view of a first electrode assembly 230, and FIG. 20C2 is a cross-sectional view of a second electrode assembly 231. FIG. 20D is a cross-sectional view taken along the dashed-dotted line E1-E2 in FIG. 20B. In FIG. 20D, the first electrode assembly 230, the second electrode assembly 231, and the separator 203 are selectively illustrated for the sake of clarity.

The storage battery 200 illustrated in FIGS. 20A, 20B, 20C1, 20C2, and 20D is different from that illustrated in FIGS. 18A to 18C in the positions of the positive electrodes 211, the negative electrodes 215, and the separator 203.

As illustrated in FIG. 20D, the storage battery 200 includes a plurality of first electrode assemblies 230 and a plurality of second electrode assemblies 231.

As illustrated in FIG. 20C1, in each of the first electrode assemblies 230, a positive electrode 211a including the positive electrode active material layers on both surfaces of a positive electrode current collector, the separator 203, a negative electrode 215a including the negative electrode active material layers on both surfaces of a negative electrode current collector, the separator 203, and the positive electrode 211a including the positive electrode active material layers on both surfaces of the positive electrode current collector are stacked in this order. As illustrated in FIG. 20C2, in each of the second electrode assemblies 231, the negative electrode 215a including the negative electrode active material layers on both surfaces of the negative electrode current collector, the separator 203, the positive electrode 211a including the positive electrode active material layers on both surfaces of the positive electrode current collector, the separator 203, and the negative electrode 215a including the negative electrode active material layers on both surfaces of the negative electrode current collector are stacked in this order.

As illustrated in FIG. 20D, the plurality of first electrode assemblies 230 and the plurality of second electrode assemblies 231 are covered with the wound separator 203.

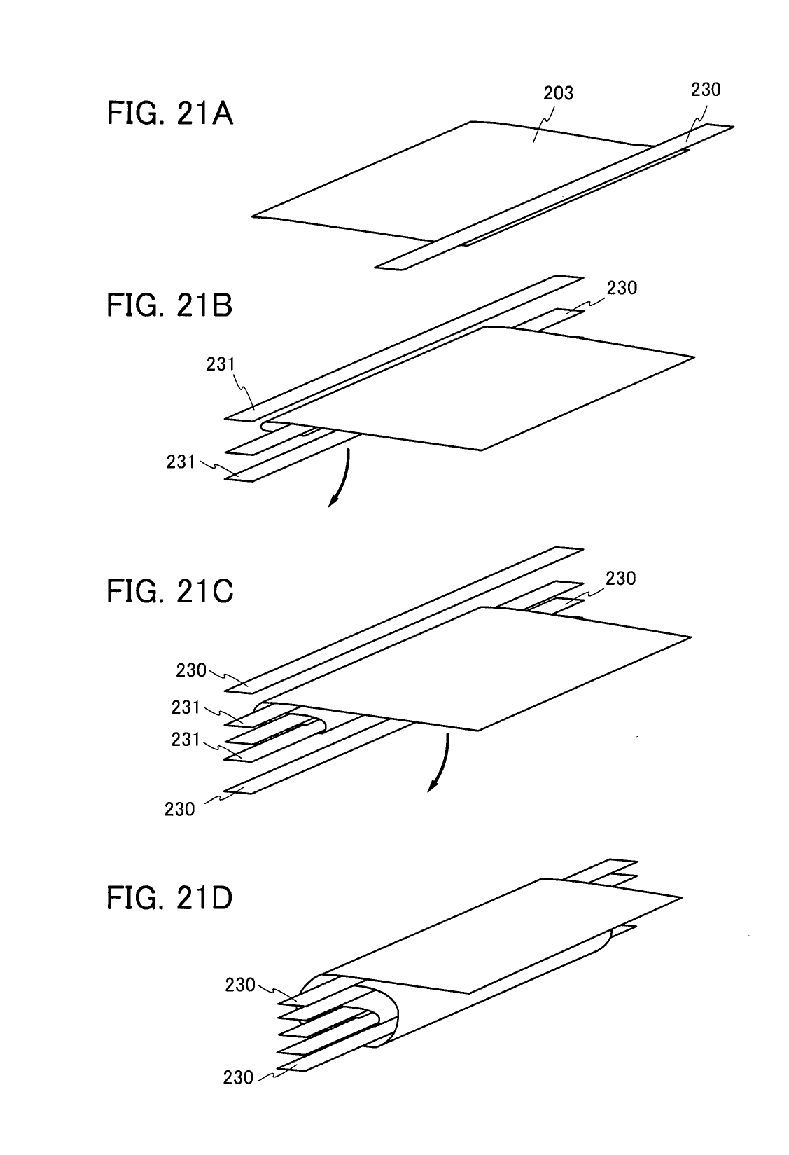

Here, some steps in the method for manufacturing the storage battery 200 illustrated in 20A, 20B, 20C1, 20C2, and 20D will be described with reference to FIGS. 21A to 21D.

First, the first electrode assembly 230 is positioned over the separator 203 (FIG. 21A).

Then, the separator 203 is folded such that part of the separator 203 is positioned over the first electrode assembly 230. Next, two second electrode assemblies 231 are positioned over and under the first electrode assembly 230 with the separator 203 therebetween (FIG. 21B).

Then, the separator 203 is wound so as to cover the two second electrode assemblies 231. Next, two first electrode assemblies 230 are positioned over and under the two second electrode assemblies 231 with the separator 203 therebetween (FIG. 21C).

Then, the separator 203 is wound so as to cover the two first electrode assemblies 230 (FIG. 21D).

Since the plurality of first electrode assemblies 230 and the plurality of second electrode assemblies 231 are stacked through the above steps, the electrode assemblies are positioned between the separator 203 that is spirally wound.

It is preferable that the positive electrode 211a of the first electrode assembly 230 that is positioned on the outermost side not include the positive electrode active material layer on the outer side.

In the example illustrated in FIGS. 20C1 and 20C2, the electrode assembly includes three electrodes and two separators; however, one embodiment of the present invention is not limited to this example. The electrode assembly may include four or more electrodes and three or more separators. As the number of electrodes is increased, the capacity of the storage battery 200 can be further improved. Note that the electrode assembly may include two electrodes and one separator. In the case where the number of electrodes is small, the storage battery 200 can have higher resistance to bending. In the example illustrated in FIG. 20D, the storage battery 200 includes three first electrode assemblies 230 and two second electrode assemblies 231; however, one embodiment of the present invention is not limited to this example. The storage battery 200 may include more electrode assemblies. As the number of electrode assemblies is increased, the capacity of the storage battery 200 can be further improved. Note that the storage battery 200 may include a smaller number of electrode assemblies. In the case where the number of electrode assemblies is small, the storage battery 200 can have higher resistance to bending.

The description of FIGS. 18A to 18C can be referred to for structures other than the positions of the positive electrodes 211, the negative electrodes 215, and the separator 203 of the storage battery 200.

### [Structural Example of Power Storage Device]

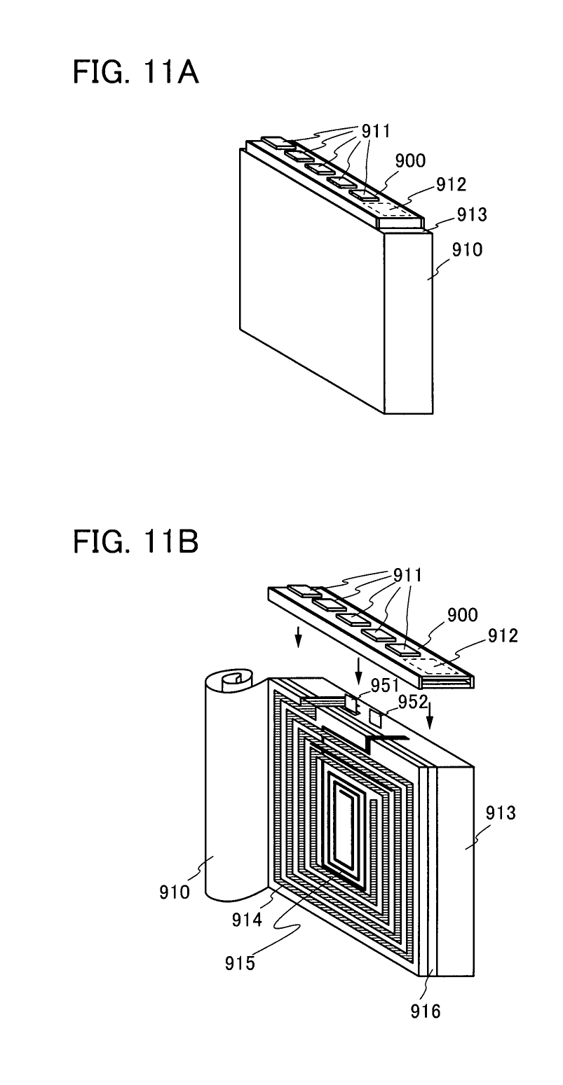

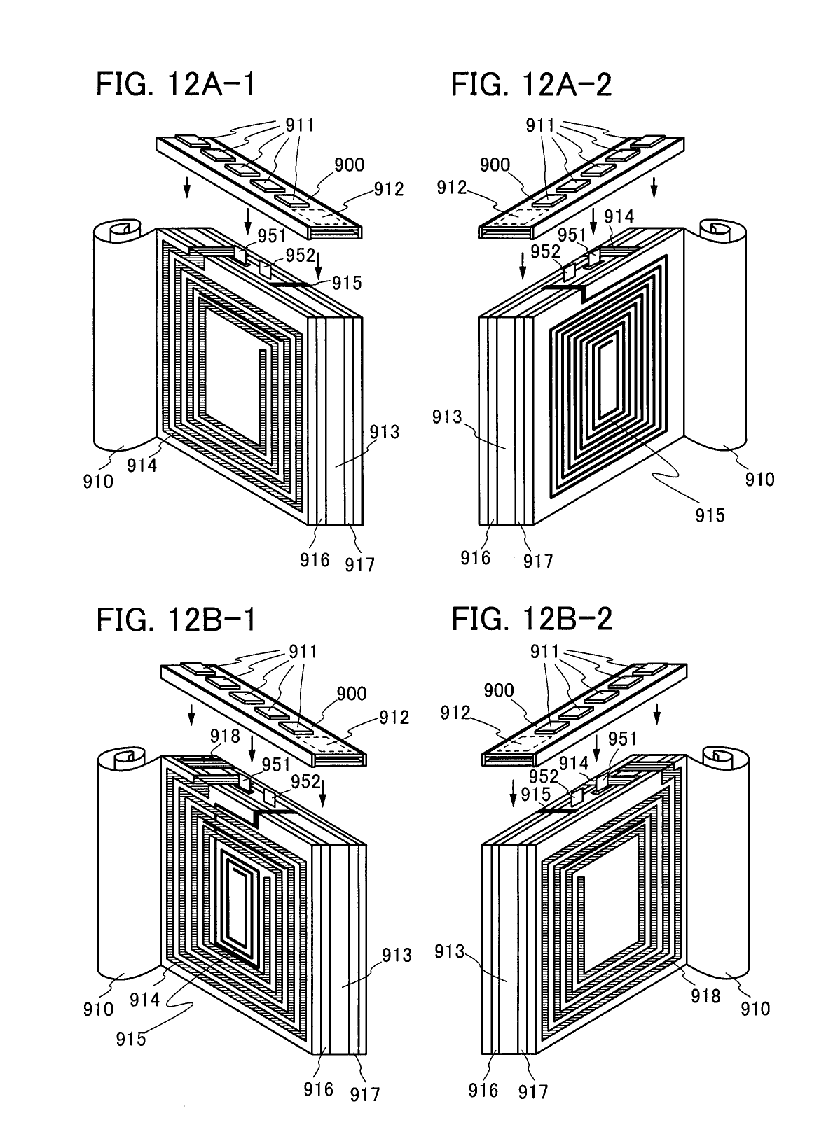

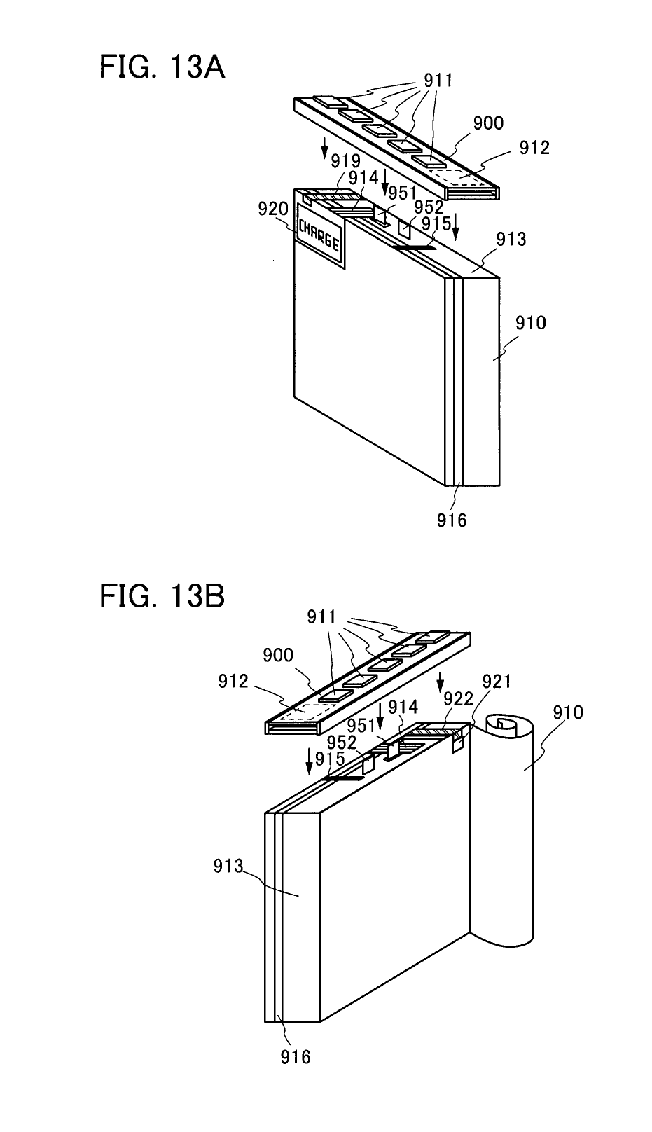

Structural examples of power storage devices will be described with reference to FIGS. 11A and 11B, FIGS. 12A1, 12A2, 12B1, and 12B2, FIGS. 13A and 13B, FIGS. 14A and 14B, and FIG. 15.

FIGS. 11A and 11B are external views of a power storage device. The power storage device includes a circuit board 900 and a storage battery 913. A label 910 is attached to the storage battery 913. As shown in FIG. 11B, the power storage device further includes a terminal 951, a terminal 952, an antenna 914, and an antenna 915.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear surface of the circuit board 900. The shape of each of the antennas 914 and 915 is not limited to a coil shape and may be a linear shape or a plate shape. Further, a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. The flat-plate conductor can serve as one of conductors for electric field coupling. That is, the antenna 914 or the antenna 915 can serve as one of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage device includes a layer 916 between the storage battery 913 and the antennas 914 and 915. The layer 916 may have a function of preventing an adverse effect on an electromagnetic field by the storage battery 913. As the layer 916, for example, a magnetic body can be used.

Note that the structure of the power storage device is not limited to that shown in FIGS. 11A and 11B.

For example, as shown in FIGS. 12A1 and 12A2, two opposite surfaces of the storage battery 913 in FIGS. 11A and 11B may be provided with respective antennas. FIG. 12A1 is an external view showing one side of the opposite surfaces, and FIG. 12A2 is an external view showing the other side of the opposite surfaces. For portions similar to those in FIGS. 11A and 11B, a description of the power storage device illustrated in FIGS. 11A and 11B can be referred to as appropriate.

As illustrated in FIG. 12A1, the antenna 914 is provided on one of the opposite surfaces of the storage battery 913 with the layer 916 interposed therebetween, and as illustrated in FIG. 12A2, the antenna 915 is provided on the other of the opposite surfaces of the storage battery 913 with a layer 917 interposed therebetween. The layer 917 may have a function of preventing an adverse effect on an electromagnetic field by the storage battery 913. As the layer 917, for example, a magnetic body can be used.

With the above structure, both of the antennas 914 and 915 can be increased in size.

Alternatively, as illustrated in FIGS. 12B1 and 12B2, two opposite surfaces of the storage battery 913 in FIGS. 11A and 11B may be provided with different types of antennas. FIG. 12B1 is an external view showing one side of the opposite surfaces, and FIG. 12B2 is an external view showing the other side of the opposite surfaces. For portions similar to those in FIGS. 11A and 11B, a description of the power storage device illustrated in FIGS. 11A and 11B can be referred to as appropriate.

As illustrated in FIG. 12B1, the antennas 914 and 915 are provided on one of the opposite surfaces of the storage battery 913 with the layer 916 interposed therebetween, and as illustrated in FIG. 12B2, an antenna 918 is provided on the other of the opposite surfaces of the storage battery 913 with the layer 917 interposed therebetween. The antenna 918 has a function of performing data communication with an external device, for example. An antenna with a shape that can be applied to the antennas 914 and 915, for example, can be used as the antenna 918. As a system for communication using the antenna 918 between the power storage device and another device, a response method that can be used between the power storage device and another device, such as NFC, can be employed.

Alternatively, as illustrated in FIG. 13A, the storage battery 913 in FIGS. 11A and 11B may be provided with a display device 920. The display device 920 is electrically connected to the terminal 911 via a terminal 919. The label 910 is not necessarily provided in a portion where the display device 920 is provided. For portions similar to those in FIGS. 11A and 11B, a description of the power storage device illustrated in FIGS. 11A and 11B can be referred to as appropriate.

The display device 920 can display, for example, an image showing whether or not charging is being carried out, an image showing the amount of stored power, or the like. As the display device 920, electronic paper, a liquid crystal display device, an electroluminescent (EL) display device, or the like can be used. For example, power consumption of the display device 920 can be reduced when electronic paper is used.

Alternatively, as illustrated in FIG. 13B, the storage battery 913 illustrated in FIGS. 11A and 11B may be provided with a sensor 921. The sensor 921 is electrically connected to the terminal 911 via a terminal 922. For portions similar to those in FIGS. 11A and 11B, a description of the power storage device illustrated in FIGS. 11A and 11B can be referred to as appropriate.

The sensor 921 has a function of measuring, for example, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays. With the sensor 921, for example, data on an environment (e.g., temperature) where the power storage device is placed can be detected and stored in a memory inside the circuit 912.

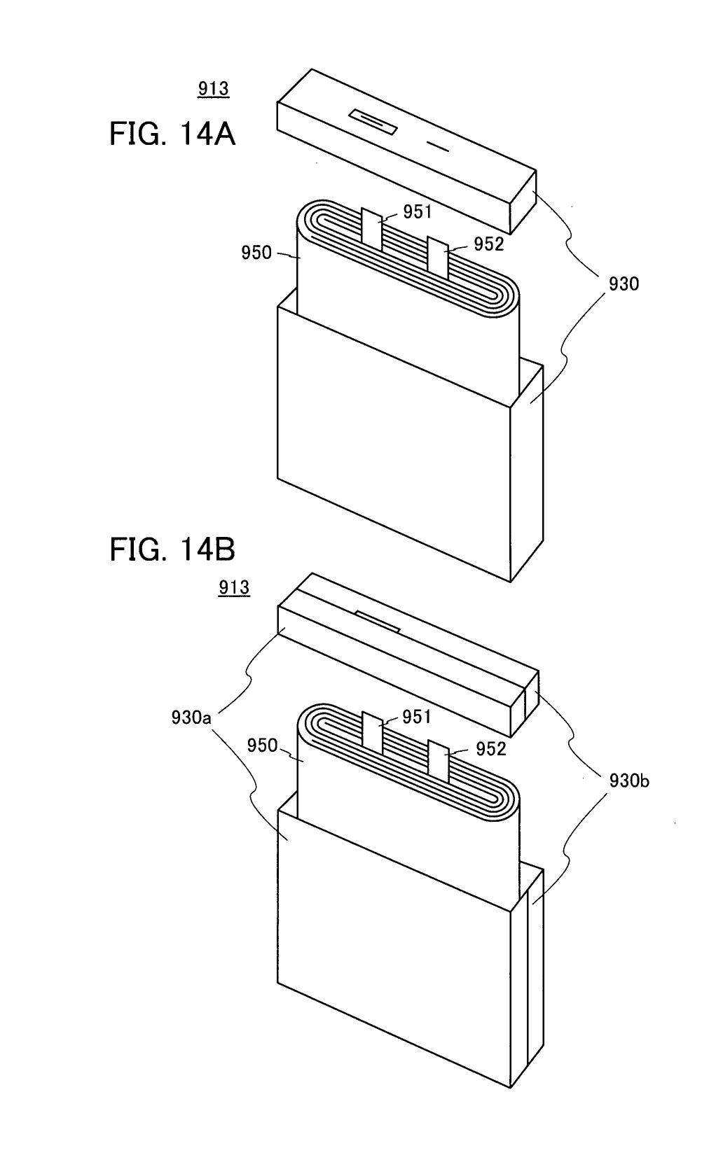

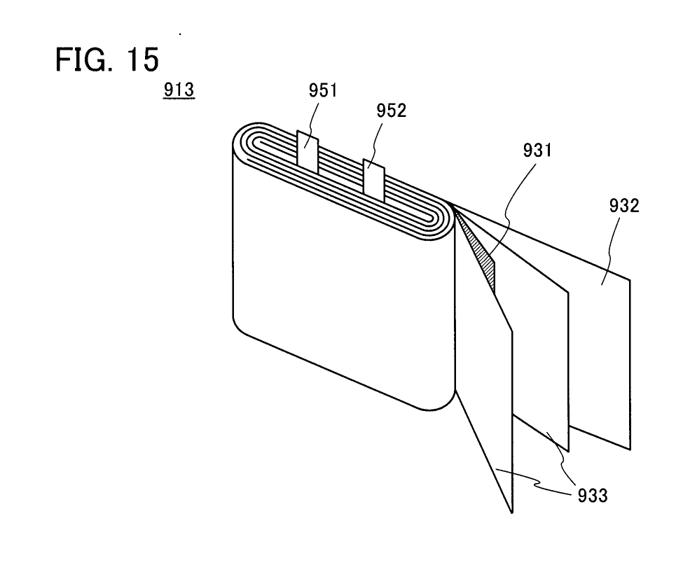

Furthermore, structural examples of the storage battery 913 will be described with reference to FIGS. 14A and 14B and FIG. 15.

The storage battery 913 illustrated in FIG. 14A includes a wound body 950 provided with the terminals 951 and 952 inside a housing 930. The wound body 950 is soaked in an electrolytic solution inside the housing 930. The terminal 952 is in contact with the housing 930. An insulator or the like prevents contact between the terminal 951 and the housing 930. Note that in FIG. 14A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 14B, the housing 930 in FIG. 14A may be formed using a plurality of materials. For example, in the storage battery 913 in FIG. 14B, a housing 930a and a housing 930b are bonded to each other and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the storage battery 913 can be prevented. Note that an antenna such as the antennas 914 and 915 may be provided inside the housing 930a if the electric field is not completely shielded by the housing 930a. For the housing 930b, a metal material can be used, for example.

FIG. 15 illustrates the structure of the wound body 950. The wound body 950 includes a negative electrode 931, a positive electrode 932, and a separator 933. The wound body 950 is obtained by winding a sheet of a stack in which the negative electrode 931 overlaps with the positive electrode 932 with the separator 933 provided therebetween. Note that a plurality of layers each including the negative electrode 931, the positive electrode 932, and the separator 933 may be stacked.

The negative electrode 931 is connected to the terminal 911 in FIGS. 11A and 11B via one of the terminals 951 and 952. The positive electrode 932 is connected to the terminal 911 in FIGS. 11A and 11B via the other of the terminals 951 and 952.

### [Examples of Electric Devices: Vehicles]

Next, examples where a storage battery is used in a vehicle will be described. The use of storage batteries in vehicles can lead to next-generation clean energy vehicles such as hybrid electric vehicles (HEVs), electric vehicles (EVs), and plug-in hybrid electric vehicles (PHEVs).

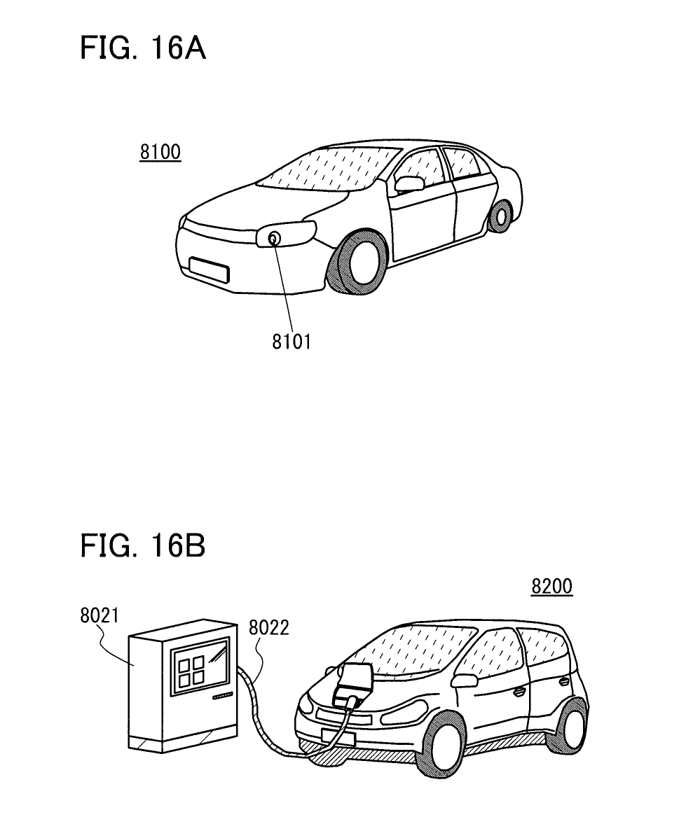

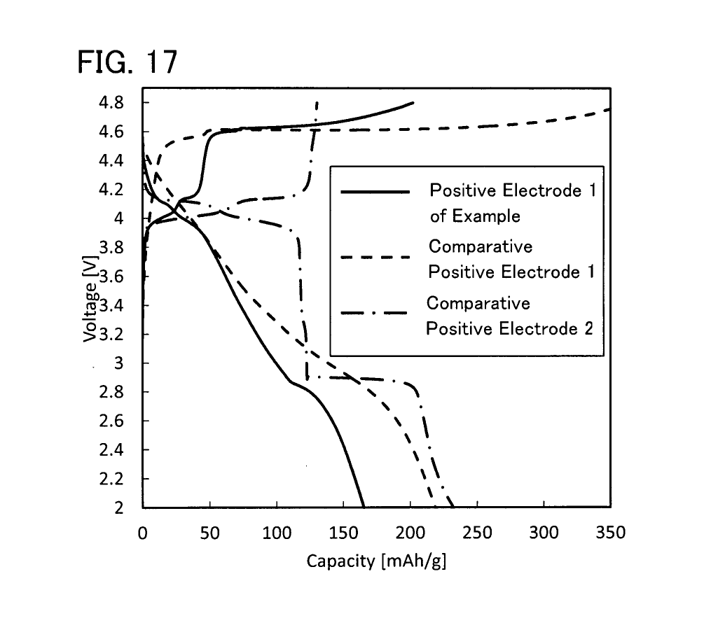

FIGS. 16A and 16B each illustrate an example of a vehicle using one embodiment of the present invention. An automobile 8100 illustrated in FIG. 16A is an electric vehicle which runs on the power of the electric motor. Alternatively, the automobile 8100 is a hybrid electric vehicle capable of driving using either the electric motor or the engine as appropriate. One embodiment of the present invention can provide a vehicle which can be repeatedly charged and discharged. The automobile 8100 includes the power storage device. The power storage device is used not only for driving the electric motor, but also for supplying electric power to a light-emitting device such as a headlight 8101 or a room light (not illustrated).

The power storage device can also supply electric power to a display device of a speedometer, a tachometer, or the like included in the automobile 8100. Furthermore, the power storage device can supply electric power to a semiconductor device included in the automobile 8100, such as a navigation system.

FIG. 16B illustrates an automobile 8200 including the power storage device. The automobile 8200 can be charged when the power storage device is supplied with electric power through external charging equipment by a plug-in system, a contactless power feeding system, or the like. In FIG. 16B, the power storage device included in the automobile 8200 is charged with the use of a ground-based charging apparatus 8021 through a cable 8022. In charging, a given method such as CHAdeMO (registered trademark) or Combined Charging System may be employed as a charging method, the standard of a connector, or the like as appropriate. The charging apparatus 8021 may be a charging station provided in a commerce facility or a power source in a house. For example, with the use of a plug-in technique, the power storage device included in the automobile 8200 can be charged by being supplied with electric power from outside. The charging can be performed by converting AC electric power into DC electric power through a converter such as an AC-DC converter.

Further, although not illustrated, the vehicle may include a power receiving device so as to be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between vehicles. Furthermore, a solar cell may be provided in the exterior of the automobile to charge the power storage device when the automobile stops or moves. To supply electric power in such a contactless manner, an electromagnetic induction method or a magnetic resonance method can be used.

According to one embodiment of the present invention, the power storage device can have improved cycle characteristics and reliability. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the driving distance. Further, the power storage device included in the vehicle can be used as a power source for supplying electric power to products other than the vehicle. In such a case, the use of a commercial power source can be avoided at peak time of electric power demand.

This embodiment can be implemented in appropriate combination with any of the other embodiments and example.

Note that in the case where at least one specific example is given in a diagram or text described in one embodiment in this specification and the like, it will be readily appreciated by those skilled in the art that a broader concept of the specific example can be derived. Therefore, in the case where at least one specific example is given in the diagram or the text described in one embodiment, a broader concept of the specific example is disclosed as one embodiment of the invention and can constitute one embodiment of the invention. The embodiment of the present invention is clear.

Note that in this specification and the like, what is illustrated in at least a diagram (or part thereof) is disclosed as one embodiment of the invention and can constitute one embodiment of the invention. Therefore, when a certain content is illustrated in a diagram, the content is disclosed as one embodiment of the invention even when the content is not described with text and can constitute one embodiment of the invention. In a similar manner, part of a diagram, which is taken out from the diagram, is disclosed as one embodiment of the invention and can constitute one embodiment of the invention. The embodiment of the present invention is clear.

### Embodiment 4

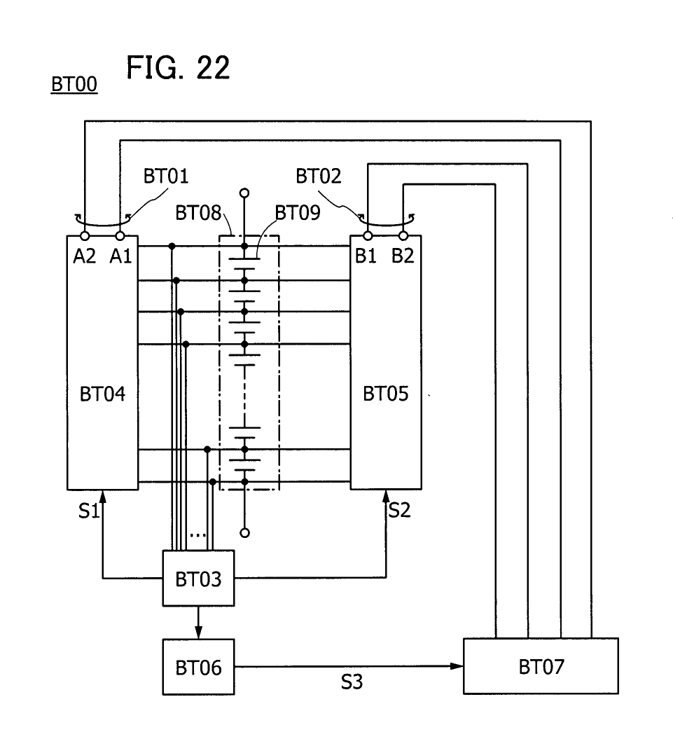

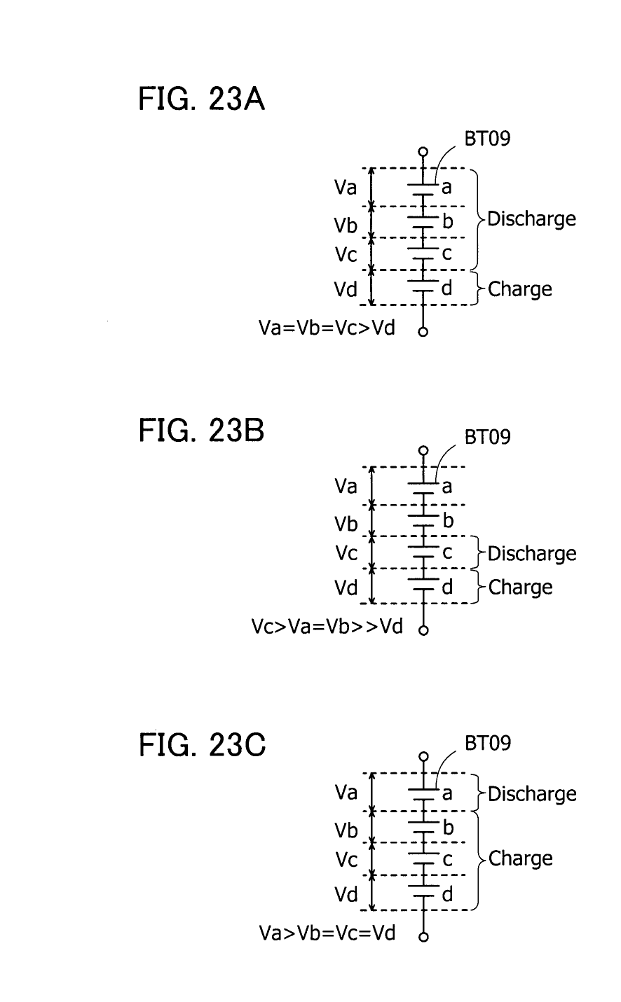

A battery management unit (BMU) that can be used in combination with battery cells each including the materials described in the above embodiment and transistors that are suitable for a circuit included in the battery management unit will be described with reference to FIG. 22, FIGS. 23A to 23C, FIG. 24, FIG. 25, FIGS. 26A to 26C, FIG. 27, and FIG. 28. In this embodiment, in particular, a battery management unit of a power storage device including battery cells connected in series will be described.

When the plurality of battery cells connected in series are repeatedly charged and discharged, there occur variations in charge and discharge characteristics among the battery cells, which causes variations in capacity (output voltage) among the battery cells. The discharge capacity of all the plurality of battery cells connected in series depends on the capacity of the battery cell that is low. The variations in capacity among the battery cells reduce the discharge capacity of all the battery cells. Furthermore, when charge is performed based on the capacity of the battery cell that is low, the battery cells might be undercharged. In contrast, when charge is performed based on the capacity of the battery cell that is high, the battery cells might be overcharged.

Thus, the battery management unit of the power storage device including the battery cells connected in series has a function of reducing variations in capacity among the battery cells, which cause an undercharge and an overcharge. Examples of a circuit configuration for reducing variations in capacity among battery cells include a resistive type, a capacitive type, and an inductive type, and a circuit configuration that can reduce variations in capacity among battery cells using transistors with a low off-state current will be explained here as an example.

A transistor including an oxide semiconductor in its channel formation region (an OS transistor) is preferably used as the transistor with a low off-state current. When an OS transistor with a low off-state current is used in the circuit of the battery management unit of the power storage device, the amount of charge that leaks from a battery can be reduced, and reduction in capacity with the lapse of time can be suppressed.

As the oxide semiconductor used in the channel formation region, an In-M-Zn oxide (M is Ga, Sn, Y, Zr, La, Ce, or Nd) is used. In the case where the atomic ratio of the metal elements of a target for forming an oxide semiconductor film is In:M:Zn=x₁:y₁, x₁/y₁ is preferably greater than or equal to ⅓ and less than or equal to 6, more preferably greater than or equal to 1 and less than or equal to 6, and z₁/y₁ is preferably greater than or equal to ⅓ and less than or equal to 6, more preferably greater than or equal to 1 and less than or equal to 6. Note that when z₁/y₁ is greater than or equal to 1 and less than or equal to 6, a CAAC-OS film as the oxide semiconductor film is easily formed.

Here, the details of the CAAC-OS film will be described.

The CAAC-OS film is one of oxide semiconductor films having a plurality of c-axis aligned crystal parts.

In a combined analysis image (also referred to as a high-resolution TEM image) of a bright-field image and a diffraction pattern of a CAAC-OS film, which is obtained using a transmission electron microscope (TEM), a plurality of crystal parts can be observed. However, in the high-resolution TEM image, a boundary between crystal parts, that is, a grain boundary is not clearly observed. Thus, in the CAAC-OS film, a reduction in electron mobility due to the grain boundary is less likely to occur.

According to the high-resolution cross-sectional TEM image of the CAAC-OS film observed in the direction substantially parallel to the sample surface, metal atoms are arranged in a layered manner in the crystal parts. Each metal atom layer reflects unevenness of a surface over which the CAAC-OS film is formed (hereinafter, a surface over which the CAAC-OS film is formed is referred to as a formation surface) or the top surface of the CAAC-OS film, and is arranged parallel to the formation surface or the top surface of the CAAC-OS film.

On the other hand, according to the plan high-resolution TEM image of the CAAC-OS film observed in the direction substantially perpendicular to the sample surface, metal atoms are arranged in a triangular or hexagonal arrangement in the crystal parts. However, there is no regularity of arrangement of metal atoms between different crystal parts.

For example, when the structure of a CAAC-OS film including an InGaZnO₄ crystal is analyzed by an out-of-plane method using an X-ray diffraction (XRD) apparatus, a peak may appear at a diffraction angle (2θ)of around 31°. This peak is derived from the (009) plane of the InGaZnO₄ crystal, which indicates that crystals in the CAAC-OS film have c-axis alignment, and that the c-axes are aligned in the direction substantially perpendicular to the formation surface or the top surface of the CAAC-OS film.

Note that in analysis of the CAAC-OS film with an InGaZnO₄ crystal by an out-of-plane method, another peak may appear when 2θ is around 36°, in addition to the peak at 2θ of around 31°. The peak of 2θ at around 36° indicates that a crystal having no c-axis alignment is included in part of the CAAC-OS film. It is preferable that in the CAAC-OS film, a peak appear when 2θ is around 31° and that a peak not appear when 2θ is around 36°.

The CAAC-OS film is an oxide semiconductor film with low impurity concentration. The impurity is an element other than the main components of the oxide semiconductor film, such as hydrogen, carbon, silicon, or a transition metal element. In particular, an element (specifically, silicon or the like) having higher strength of bonding to oxygen than a metal element included in an oxide semiconductor film extracts oxygen from the oxide semiconductor film, which results in disorder of the atomic arrangement and reduced crystallinity of the oxide semiconductor film. Furthermore, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source.

The CAAC-OS film is an oxide semiconductor film having a low density of defect states. In some cases, oxygen vacancies in the oxide semiconductor film serve as carrier traps or serve as carrier generation sources when hydrogen is captured therein, for example.

The state in which impurity concentration is low and density of defect states is low (the number of oxygen vacancies is small) is referred to as a “highly purified intrinsic” or “substantially highly purified intrinsic” state. A highly purified intrinsic or substantially highly purified intrinsic oxide semiconductor film has few carrier generation sources, and thus can have a low carrier density. Thus, a transistor including the oxide semiconductor film rarely has negative threshold voltage (is rarely normally on). The highly purified intrinsic or substantially highly purified intrinsic oxide semiconductor film has few carrier traps. Accordingly, the transistor including the oxide semiconductor film has little variation in electrical characteristics and high reliability. Charge trapped by the carrier traps in the oxide semiconductor film takes a long time to be released, and might behave like fixed charge. Thus, the transistor which includes the oxide semiconductor film having high impurity concentration and a high density of defect states has unstable electrical characteristics in some cases.

With the use of the CAAC-OS film in a transistor, variation in the electrical characteristics of the transistor due to irradiation with visible light or ultraviolet light is small.

Since the OS transistor has a wider band gap than a transistor including silicon in its channel formation region (a Si transistor), dielectric breakdown is unlikely to occur when a high voltage is applied. Although a voltage of several hundreds of volts is generated when battery cells are connected in series, the above-described OS transistor is suitable for a circuit of a battery management unit which is used for such battery cells in the power storage device.

FIG. 22 is an example of a block diagram of the power storage device. A power storage device BT00 illustrated in FIG. 22 includes a terminal pair BT01, a terminal pair BT02, a switching control circuit BT03, a switching circuit BT04, a switching circuit BT05, a voltage transformation control circuit BT06, a voltage transformer circuit BT07, and a battery portion BT08 including a plurality of battery cells BT09 connected in series.

In the power storage device BT00 illustrated in FIG. 22, a portion including the terminal pair BT01, the terminal pair BT02, the switching control circuit BT03, the switching circuit BT04, the switching circuit BT05, the voltage transformation control circuit BT06, and the voltage transformer circuit BT07 can be referred to as a battery management unit.

The switching control circuit BT03 controls operations of the switching circuits BT04 and BT05. Specifically, the switching control circuit BT03 selects battery cells to be discharged (a discharge battery cell group) and battery cells to be charged (a charge battery cell group) in accordance with voltage measured for every battery cell BT09.

Furthermore, the switching control circuit BT03 outputs a control signal S1 and a control signal S2 on the basis of the selected discharge battery cell group and the selected charge battery cell group. The control signal S1 is output to the switching circuit BT04. The control signal S1 controls the switching circuit BT04 so that the terminal pair BT01 and the discharge battery cell group are connected. In addition, the control signal S2 is output to the switching circuit BT05. The control signal S2 controls the switching circuit BT05 so that the terminal pair BT02 and the charge battery cell group are connected.

The switching control circuit BT03 generates the control signal S1 and the control signal S2 on the basis of the connection relation of the switching circuit BT04, the switching circuit BT05, and the voltage transformer circuit BT07 so that terminals having the same polarity of the terminal pair BT01 and the discharge battery cell group are connected with each other, or terminals having the same polarity of the terminal pair BT02 and the charge battery cell group are connected with each other.

The operations of the switching control circuit BT03 will be described in detail.

First, the switching control circuit BT03 measures the voltage of each of the plurality of battery cells BT09. Then, the switching control circuit BT03 determines that the battery cell BT09 having a voltage higher than a predetermined threshold value is a high-voltage battery cell (high-voltage cell) and that the battery cell BT09 having a voltage lower than the predetermined threshold value is a low-voltage battery cell (low-voltage cell), for example.

As a method to determine whether a battery cell is a high-voltage cell or a low-voltage cell, any of various methods can be employed. For example, the switching control circuit BT03 may determine whether each battery cell BT09 is a high-voltage cell or a low-voltage cell on the basis of the voltage of the battery cell BT09 having the highest voltage or the lowest voltage among the plurality of battery cells BT09. In this case, the switching control circuit BT03 can determine whether each battery cell BT09 is a high-voltage cell or a low-voltage cell by, for example, determining whether or not the ratio of the voltage of each battery cell BT09 to the reference voltage is the predetermined value or more. Then, the switching control circuit BT03 determines a charge battery cell group and a discharge battery cell group on the basis of the determination result.

Note that high-voltage cells and low-voltage cells are mixed in various states in the plurality of battery cells BT09. For example, the switching control circuit BT03 selects a portion having the largest number of high-voltage cells connected in series as the discharge battery cell group of mixed high-voltage cells and low-voltage cells. Furthermore, the switching control circuit BT03 selects a portion having the largest number of low-voltage cells connected in series as the charge battery cell group. In addition, the switching control circuit BT03 may preferentially select the battery cells BT09 which are almost overcharged or overdischarged as the discharge battery cell group or the charge battery cell group.

Here, operation examples of the switching control circuit BT03 in this embodiment will be described with reference to FIGS. 23A to 23C. FIGS. 23A to 23C illustrate the operation examples of the switching control circuit BT03. Note that FIGS. 23A to 23C each illustrate the case where four battery cells BT09 are connected in series as an example for convenience of explanation.

FIG. 23A shows the case where the relation of voltages Va, Vb, Vc, and Vd is Va=Vb=Vc>Vd where the voltages Va, Vb, Vc, and Vd are the voltages of a battery cell a, a battery cell b, a battery cell c, and a battery cell d, respectively. That is, a series of three high-voltage cells a to c and one low-voltage cell d are connected in series. In this case, the switching control circuit BT03 selects the series of three high-voltage cells a to c as the discharge battery cell group. In addition, the switching control circuit BT03 selects the low-voltage cell d as the charge battery cell group.

Next, FIG. 23B shows the case where the relation of the voltages is Vc>Va=Vb>>Vd. That is, a series of two low-voltage cells a and b, one high-voltage cell c, and one low-voltage cell d which is almost overdischarged are connected in series. In this case, the switching control circuit BT03 selects the high-voltage cell c as the discharge battery cell group. Since the low-voltage cell d is almost overdischarged, the switching control circuit BT03 preferentially selects the low-voltage cell d as the charge battery cell group instead of the series of two low-voltage cells a and b.

Lastly, FIG. 23C shows the case where the relation of the voltages is Va>Vb=Vc=Vd. That is, one high-voltage cell a and a series of three low-voltage cells b to d are connected in series. In this case, the switching control circuit BT03 selects the high-voltage cell a as the discharge battery cell group. In addition, the switching control circuit BT03 selects the series of three low-voltage cells b to d as the charge battery cell group.

On the basis of the determination result shown in the examples of FIGS. 23A to 23C, the switching control circuit BT03 outputs the control signal S1 and the control signal S2 to the switching circuit BT04 and the switching circuit BT05, respectively. Information showing the discharge battery cell group, which is the connection destination of the switching circuit BT04, is set in the control signal S1. Information showing the charge battery cell group, which is the connection destination of the switching circuit BT05, is set in the control signal S2.

The above is the detailed description of the operations of the switching control circuit BT03.

The switching circuit BT04 sets the discharge battery cell group selected by the switching control circuit BT03 as the connection destination of the terminal pair BT01 in response to the control signal S1 output from the switching control circuit BT03.

The terminal pair BT01 includes a pair of terminals A1 and A2. The switching circuit BT04 connects one of the pair of terminals A1 and A2 to a positive electrode terminal of the battery cell BT09 positioned on the most upstream side (on the high potential side) of the discharge battery cell group, and the other to a negative electrode terminal of the battery cell BT09 positioned on the most downstream side (on the low potential side) of the discharge battery cell group. Note that the switching circuit BT04 can recognize the position of the discharge battery cell group on the basis of the information set in the control signal S1.

The switching circuit BT05 sets the charge battery cell group selected by the switching control circuit BT03 as the connection destination of the terminal pair BT02 in response to the control signal S2 output from the switching control circuit BT03.

The terminal pair BT02 includes a pair of terminals B1 and B2. The switching circuit BT05 connects one of the pair of terminals B1 and B2 to a positive electrode terminal of the battery cell BT09 positioned on the most upstream side (on the high potential side) of the charge battery cell group, and the other to a negative electrode terminal of the battery cell BT09 positioned on the most downstream side (on the low potential side) of the charge battery cell group. Note that the switching circuit BT05 can recognize the position of the charge battery cell group on the basis of the information set in the control signal S2.

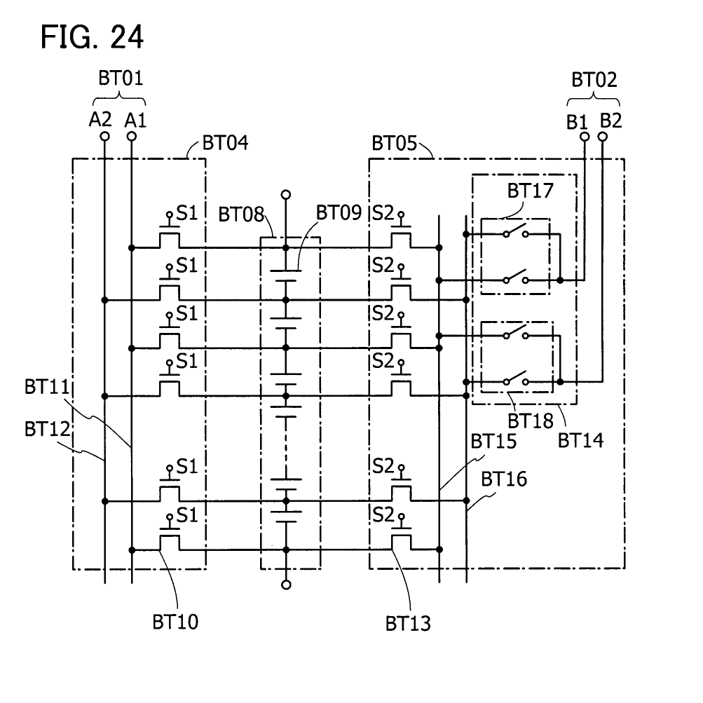

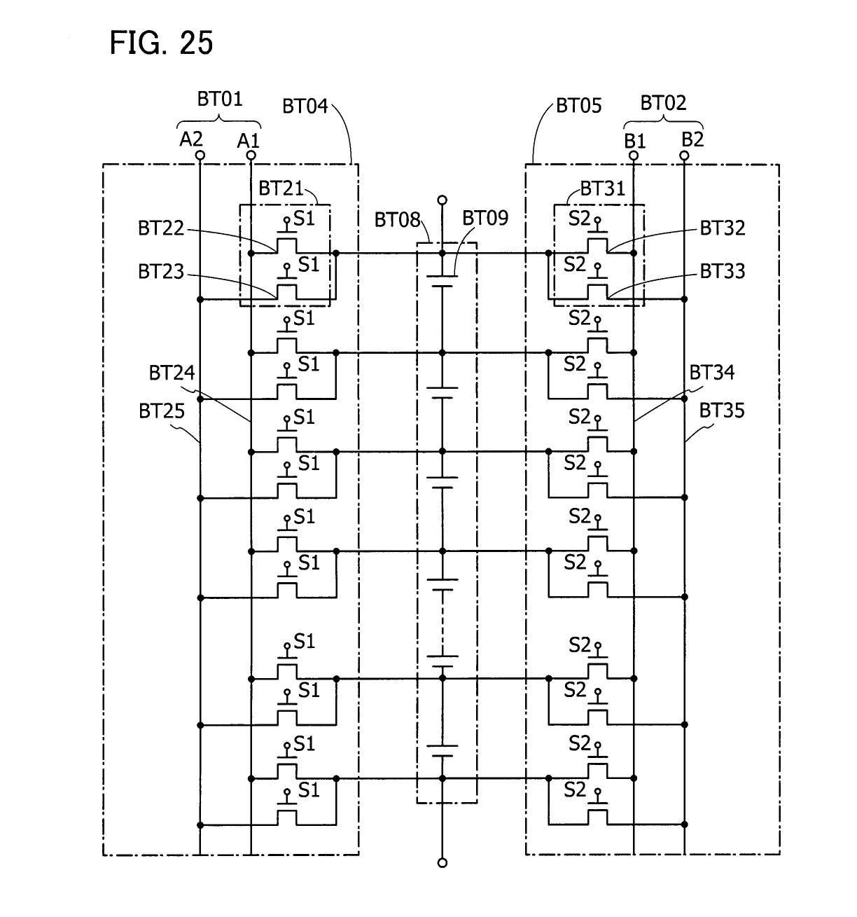

FIG. 24 and FIG. 25 are circuit diagrams showing configuration examples of the switching circuits BT04 and BT05.

In FIG. 24, the switching circuit BT04 includes a plurality of transistors BT10, a bus BT11, and a bus BT12. The bus BT11 is connected to the terminal A1. The bus BT12 is connected to the terminal A2. Sources or drains of the plurality of transistors BT10 are connected alternately to the bus BT11 and the bus BT12. The sources or drains which are not connected to the bus BT11 or the bus BT12 of the plurality of transistors BT10 are each connected between two adjacent battery cells BT09.

The source or drain of the transistor BT10 which is not connected to the bus BT12 on the most upstream side of the plurality of transistors BT10 is connected to the positive electrode terminal of the battery cell BT09 on the most upstream side of the battery portion BT08. The source or drain of the transistor BT10 which is not connected to the bus BT12 of the transistor BT10 on the most downstream side of the plurality of transistors BT10 is connected to the negative electrode terminal of the battery cell BT09 on the most downstream side of the battery portion BT08.

The switching circuit BT04 connects the discharge battery cell group to the terminal pair BT01 by bringing one of the plurality of transistors BT10 which are connected to the bus BT11 and one of the plurality of transistors BT10 which are connected to the bus BT12 into an on state in response to the control signal S1 supplied to gates of the plurality of transistors BT10. Accordingly, the positive electrode terminal of the battery cell BT09 on the most upstream side of the discharge battery cell group is connected to one of the pair of terminals A1 and A2. In addition, the negative electrode terminal of the battery cell BT09 on the most downstream side of the discharge battery cell group is connected to the other of the pair of terminals A1 and A2 (i.e., a terminal which is not connected to the positive electrode terminal).

An OS transistor is preferably used as the transistor BT10. Since the off-state current of the OS transistor is low, the amount of charge that leaks from the battery cell which does not belong to the discharge battery cell group can be reduced, and reduction in capacity with the lapse of time can be suppressed. In addition, dielectric breakdown is unlikely to occur in the OS transistor when a high voltage is applied. Therefore, the battery cell BT09 and the terminal pair BT01, which are connected to the transistor BT10 in an off state, can be insulated from each other even when the output voltage of the discharge battery cell group is high.

In FIG. 24, the switching circuit BT05 includes a plurality of transistors BT13, a current control switch BT14, a bus BT15, and a bus BT16. The bus BT15 and the bus BT16 are provided between the plurality of transistor BT13 and the current control switch BT14. Sources or drains of the plurality of transistors BT13 are connected alternately to the bus BT15 and the bus BT16. Sources or drains which are not connected to the bus BT15 or the bus BT16 of the plurality of transistors BT13 are each connected between two adjacent battery cells BT09.

The source or drain of the transistor BT13 which is not connected to the bus BT16 on the most upstream side of the plurality of transistors BT13 is connected to the positive electrode terminal of the battery cell BT09 on the most upstream side of the battery portion BT08. The source or drain of the transistor BT13 which is not connected to the bus BT16 on the most downstream side of the plurality of transistors BT13 is connected to the negative electrode terminal of the battery cell BT09 on the most downstream side of the battery portion BT08.

An OS transistor is preferably used as the transistors BT13 like the transistors BT10. Since the off-state current of the OS transistor is low, the amount of charge that leaks from the battery cells which do not belong to the charge battery cell group can be reduced, and reduction in capacity with the lapse of time can be suppressed. In addition, dielectric breakdown is unlikely to occur in the OS transistor when a high voltage is applied. Therefore, the battery cell BT09 and the terminal pair BT02, which are connected to the transistor BT13 in an off state, can be insulated from each other even when a voltage for charging the charge battery cell group is high.

The current control switch BT14 includes a switch pair BT17 and a switch pair BT18. Terminals on one end of the switch pair BT17 are connected to the terminal B1. Terminals on the other end of the switch pair BT17 extend from two switches. One switch is connected to the bus BT15, and the other switch is connected to the bus BT16. Terminals on one end of the switch pair BT18 are connected to the terminal B2. Terminals on the other end of the switch pair BT18 extend from two switches. One switch is connected to the bus BT15, and the other switch is connected to the bus BT16.

OS transistors are preferably used for the switches included in the switch pair BT17 and the switch pair BT18 like the transistors BT10 and BT13.

The switching circuit BT05 connects the charge battery cell group and the terminal pair BT02 by controlling the combination of on and off states of the transistors BT13 and the current control switch BT14 in response to the control signal S2.

For example, the switching circuit BT05 connects the charge battery cell group and the terminal pair BT02 in the following manner.

The switching circuit BT05 brings a transistor BT13 connected to the positive electrode terminal of the battery cell BT09 on the most upstream side of the charge battery cell group into an on state in response to the control signal S2 supplied to gates of the plurality of transistors BT13. In addition, the switching circuit BT05 brings a transistor BT13 connected to the negative electrode terminal of the battery cell BT09 on the most downstream side of the charge battery cell group into an on state in response to the control signal S2 supplied to the gates of the plurality of transistors BT13.

The polarities of voltages applied to the terminal pair BT02 can vary in accordance with the configurations of the voltage transformer circuit BT07 and the discharge battery cell group connected to the terminal pair BT01. In order to supply a current in the direction for charging the charge battery cell group, terminals with the same polarity of the terminal pair BT02 and the charge battery cell group are required to be connected to each other. In view of this, the current control switch BT14 is controlled by the control signal S2 so that the connection destination of the switch pair BT17 and that of the switch pair BT18 are changed in accordance with the polarities of the voltages applied to the terminal pair BT02.

The state where voltages are applied to the terminal pair BT02 so as to make the terminal B1 a positive electrode and the terminal B2 a negative electrode will be described as an example. Here, in the case where the battery cell BT09 positioned on the most downstream side of the battery portion BT08 is in the charge battery cell group, the switch pair BT17 is controlled to be connected to the positive electrode terminal of the battery cell BT09 in response to the control signal S2. That is, the switch of the switch pair BT17 connected to the bus BT16 is turned on, and the switch of the switch pair BT17 connected to the bus BT15 is turned off. In contrast, the switch pair BT18 is controlled to be connected to the negative electrode terminal of the battery cell BT09 positioned on the most downstream side of the battery portion BT08 in response to the control signal S2. That is, the switch of the switch pair BT18 connected to the bus BT15 is turned on, and the switch of the switch pair BT18 connected to the bus BT16 is turned off. In this manner, terminals with the same polarity of the terminal pair BT02 and the charge battery cell group are connected to each other. In addition, the current which flows from the terminal pair BT02 is controlled to be supplied in a direction so as to charge the charge battery cell group.

In addition, instead of the switching circuit BT05, the switching circuit BT04 may include the current control switch BT14. In that case, the polarities of the voltages applied to the terminal pair BT02 are controlled by controlling the polarities of the voltages applied to the terminal pair BT01 in response to the operation of the current control switch BT14 and the control signal S1. Thus, the current control switch BT14 controls the direction of current which flows to the charge battery cell group from the terminal pair BT02.

FIG. 25 is a circuit diagram illustrating configuration examples of the switching circuit BT04 and the switching circuit BT05 which are different from those of FIG. 24.

In FIG. 25, the switching circuit BT04 includes a plurality of transistor pairs BT21, a bus BT24, and a bus BT25. The bus BT24 is connected to the terminal A1. The bus BT25 is connected to the terminal A2. Terminals on one end of each of the plurality of transistor pairs BT21 extend from a transistor BT22 and a transistor BT23. Sources or drains of the transistors BT22 are connected to the bus BT24. Sources or drains of the transistors BT23 are connected to the bus BT25. In addition, terminals on the other end of each of the plurality of transistor pairs BT21 are connected between two adjacent battery cells BT09. The terminals on the other end of the transistor pair BT21 on the most upstream side of the plurality of transistor pairs BT21 are connected to the positive electrode terminal of the battery cell BT09 on the most upstream side of the battery portion BT08. The terminals on the other end of the transistor pair BT21 on the most downstream side of the plurality of transistor pairs BT21 are connected to a negative electrode terminal of the battery cell BT09 on the most downstream side of the battery portion BT08.

The switching circuit BT04 switches the connection destination of the transistor pair BT21 to one of the terminal A1 and the terminal A2 by turning on or off the transistors BT22 and BT23 in response to the control signal S1. Specifically, when the transistor BT22 is turned on, the transistor BT23 is turned off, so that the connection destination of the transistor pair BT21 is the terminal A1. On the other hand, when the transistor BT23 is turned on, the transistor BT22 is turned off, so that the connection destination of the transistor pair BT21 is the terminal A2. Which of the transistors BT22 and BT23 is turned on is determined by the control signal S1.

Two transistor pairs BT21 are used to connect the terminal pair BT01 and the discharge battery cell group. Specifically, the connection destinations of the two transistor pairs BT21 are determined on the basis of the control signal S1, and the discharge battery cell group and the terminal pair BT01 are connected. The connection destinations of the two transistor pairs BT21 are controlled by the control signal S1 so that one of the connection destinations is the terminal A1 and the other is the terminal A2.

The switching circuit BT05 includes a plurality of transistor pairs BT31, a bus BT34 and a bus BT35. The bus BT34 is connected to the terminal B1. The bus BT35 is connected to the terminal B2. Terminals on one end of each of the plurality of transistor pairs BT31 extend from a transistor BT32 and a transistor BT33. The terminal on one end extending from the transistor BT32 is connected to the bus BT34. The terminal on one end extending from the transistor BT33 is connected to the bus BT35. Terminals on the other end of each of the plurality of transistor pairs BT31 are connected between two adjacent battery cells BT09. The terminal on the other end of the transistor pair BT31 on the most upstream side of the plurality of transistor pairs BT31 is connected to the positive electrode terminal of the battery cell BT09 on the most upstream side of the battery portion BT08. The terminal on the other end of the transistor pair BT31 on the most downstream side of the plurality of transistor pairs BT31 is connected to the negative electrode terminal of the battery cell BT09 on the most downstream side of the battery portion BT08.

The switching circuit BT05 switches the connection destination of the transistor pair BT31 to one of the terminal B1 and the terminal B2 by turning on or off the transistors BT32 and BT33 in response to the control signal S2. Specifically, when the transistor BT32 is turned on, the transistor BT33 is turned off, so that the connection destination of the transistor pair BT31 is the terminal B1. On the other hand, when the transistor BT33 is turned on, the transistor BT32 is turned off, so that the connection destination of the transistor pair BT31 is the terminal B2. Which of the transistors BT32 and BT33 is turned on is determined by the control signal S2.

Two transistor pairs BT31 are used to connect the terminal pair BT02 and the charge battery cell group. Specifically, the connection destinations of the two transistor pairs BT31 are determined on the basis of the control signal S2, and the charge battery cell group and the terminal pair BT02 are connected. The connection destinations of the two transistor pairs BT31 are controlled by the control signal S2 so that one of the connection destinations is the terminal B1 and the other is the terminal B2.

The connection destinations of the two transistor pairs BT31 are determined by the polarities of the voltages applied to the terminal pair BT02. Specifically, in the case where voltages which make the terminal B1 a positive electrode and the terminal B2 a negative electrode are applied to the terminal pair BT02, the transistor pair BT31 on the upstream side is controlled by the control signal S2 so that the transistor BT32 is turned on and the transistor BT33 is turned off. In contrast, the transistor pair BT31 on the downstream side is controlled by the control signal S2 so that the transistor BT33 is turned on and the transistor BT32 is turned off. In the case where voltages which make the terminal B1 a negative electrode and the terminal B2 a positive electrode are applied to the terminal pair BT02, the transistor pair BT31 on the upstream side is controlled by the control signal S2 so that the transistor BT33 is turned on and the transistor BT32 is turned off. In contrast, the transistor pair BT31 on the downstream side is controlled by the control signal S2 so that the transistor BT32 is turned on and the transistor BT33 is turned off. In this manner, terminals with the same polarity of the terminal pair BT02 and the charge battery cell group are connected to each other. In addition, the current which flows from the terminal pair BT02 is controlled to be supplied in the direction for charging the charge battery cell group.

The voltage transformation control circuit BT06 controls the operation of the voltage transformer circuit BT07. The voltage transformation control circuit BT06 generates a voltage transformation signal S3 for controlling the operation of the voltage transformer circuit BT07 on the basis of the number of the battery cells BT09 included in the discharge battery cell group and the number of the battery cells BT09 included in the charge battery cell group and outputs the voltage transformation signal S3 to the voltage transformer circuit BT07.

In the case where the number of the battery cells BT09 included in the discharge battery cell group is larger than that included in the charge battery cell group, it is necessary to prevent a charging voltage which is too high from being applied to the charge battery cell group. Thus, the voltage transformation control circuit BT06 outputs the voltage transformation signal S3 for controlling the voltage transformer circuit BT07 so that a discharging voltage (Vdis) is lowered within a range where the charge battery cell group can be charged.

In the case where the number of the battery cells BT09 included in the discharge battery cell group is less than or equal to that included in the charge battery cell group, a charging voltage necessary for charging the charge battery cell group needs to be ensured. Therefore, the voltage transformation control circuit BT06 outputs the voltage transformation signal S3 for controlling the voltage transformer circuit BT07 so that the discharging voltage (Vdis) is raised within a range where a charging voltage which is too high is not applied to the charge battery cell group.

The voltage value of the charging voltage which is too high is determined in the light of product specifications and the like of the battery cell BT09 used in the battery portion BT08. The voltage which is raised or lowered by the voltage transformer circuit BT07 is applied as a charging voltage (Vcha) to the terminal pair BT02.

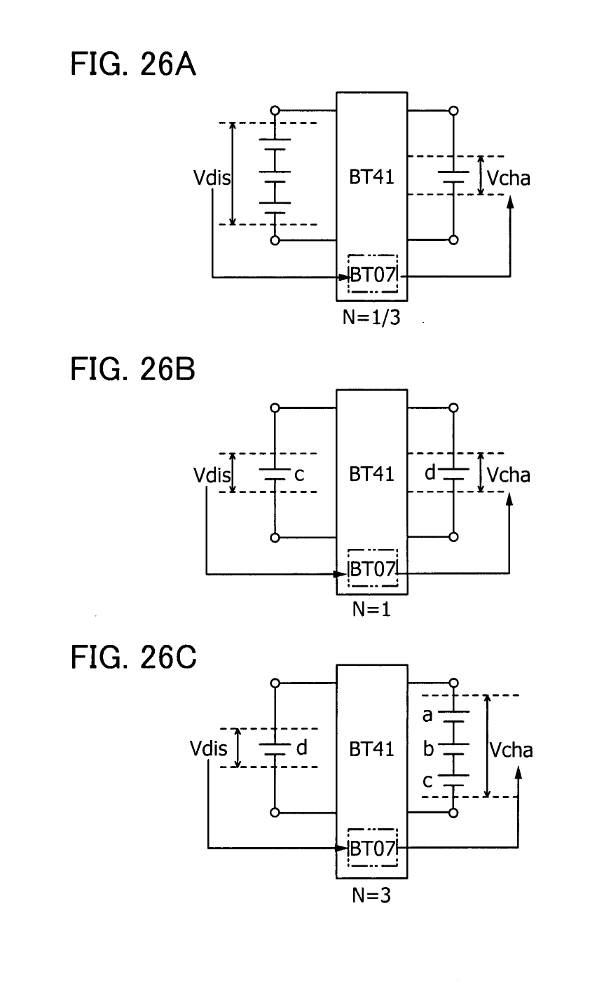

Here, operation examples of the voltage transformation control circuit BT06 in this embodiment will be described with reference to FIGS. 26A to 26C. FIGS. 26A to 26C are conceptual diagrams for explaining the operation examples of the voltage transformation control circuit BT06 corresponding to the discharge battery cell group and the charge battery cell group described in FIGS. 23A to 23C. FIGS. 26A to 26C each illustrate a battery control unit BT41. As described above, the battery control unit BT41 includes the terminal pair BT01, the terminal pair BT02, the switching control circuit BT03, the switching circuit BT04, the switching circuit BT05, the voltage transformation control circuit BT06, and the voltage transformer circuit BT07.

In the example illustrated in FIG. 26A, the series of three high-voltage cells a to c and one low-voltage cell d are connected in series as in FIG. 23A. In that case, as described using FIG. 23A, the switching control circuit BT03 selects the high-voltage cells a to c as the discharge battery cell group, and selects the low-voltage cell d as the charge battery cell group. The voltage transformation control circuit BT06 calculates a conversion ratio N for converting the discharging voltage (Vdis) to the charging voltage (Vcha) on the basis of the ratio of the number of the battery cells BT09 included in the charge battery cell group to the number of the battery cells BT09 included in the discharge battery cell group.

In the case where the number of the battery cells BT09 included in the discharge battery cell group is larger than that included in the charge battery cell group, when a discharging voltage is applied to the terminal pair BT02 without transforming the voltage, an overvoltage may be applied to the battery cells BT09 included in the charge battery cell group through the terminal pair BT02. Thus, in the case of FIG. 26A, it is necessary that a charging voltage (Vcha) applied to the terminal pair BT02 be lower than the discharging voltage. In addition, in order to charge the charge battery cell group, it is necessary that the charging voltage be higher than the total voltage of the battery cells BT09 included in the charge battery cell group. Thus, the transformation control circuit BT06 sets the conversion ratio N larger than the ratio of the number of the battery cells BT09 included in the charge battery cell group to the number of the battery cells BT09 included in the discharge battery cell group.

Thus, the voltage transformation control circuit BT06 preferably sets the conversion ratio N larger than the ratio of the number of the battery cells BT09 included in the charge battery cell group to the number of the battery cells BT09 included in the discharge battery cell group by about 1% to 10%. Here, the charging voltage is made higher than the voltage of the charge battery cell group, but the charging voltage is equal to the voltage of the charge battery cell group in reality. Note that the voltage transformation control circuit BT06 feeds a current for charging the charge battery cell group in accordance with the conversion ratio N in order to make the voltage of the charge battery cell group equal to the charging voltage. The value of the current is set by the voltage transformation control circuit BT06.

In the example illustrated in FIG. 26A, since the number of the battery cells BT09 included in the discharge battery cell group is three and the number of the battery cells BT09 included in the charge battery cell group is one, the voltage transformation control circuit BT06 calculates a value which is slightly larger than ⅓ as the conversion ratio N. Then, the voltage transformation control circuit BT06 outputs the voltage transformation signal S3, which lowers the discharging voltage in accordance with the conversion ratio N and converts the voltage into a charging voltage, to the voltage transformer circuit BT07. The transformer circuit BT07 applies the charging voltage which is transformed in response to the transformation signal S3 to the terminal pair BT02. Then, the battery cells BT09 included in the charge battery cell group are charged with the charging voltage applied to the terminal pair BT02.

In each of examples illustrated in FIGS. 26B and 26C, the conversion ratio N is calculated in a manner similar to that of FIG. 26A. In each of the examples illustrated in FIGS. 26B and 26C, since the number of the battery cells BT09 included in the discharge battery cell group is less than or equal to the number of the battery cells BT09 included in the charge battery cell group, the conversion ratio N is 1 or more. Therefore, in this case, the voltage transformation control circuit BT06 outputs the voltage transformation signal S3 for raising the discharging voltage and converting the voltage into the charging voltage.

The voltage transformer circuit BT07 converts the discharging voltage applied to the terminal pair BT01 into a charging voltage in response to the voltage transformation signal S3. The voltage transformer circuit BT07 applies the charging voltage to the terminal pair BT02. Here, the voltage transformer circuit BT07 electrically insulates the terminal pair BT01 from the terminal pair BT02. Accordingly, the voltage transformer circuit BT07 prevents a short circuit due to a difference between the absolute voltage of the negative electrode terminal of the battery cell BT09 on the most downstream side of the discharge battery cell group and the absolute voltage of the negative electrode terminal of the battery cell BT09 on the most downstream side of the charge battery cell group. Furthermore, the voltage transformer circuit BT07 converts the discharging voltage, which is the total voltage of the discharge battery cell group, into the charging voltage in response to the voltage transformation signal S3 as described above.

An insulated direct current (DC)-DC converter or the like can be used in the voltage transformer circuit BT07. In that case, the voltage transformation control circuit BT06 controls the charging voltage converted by the voltage transformer circuit BT07 by outputting a signal for controlling the on/off ratio (the duty ratio) of the insulated DC-DC converter as the voltage transformation signal S3.

Examples of the insulated DC-DC converter include a flyback converter, a forward converter, a ringing choke converter (RCC), a push-pull converter, a half-bridge converter, and a full-bridge converter, and a suitable converter is selected in accordance with the value of the intended output voltage.

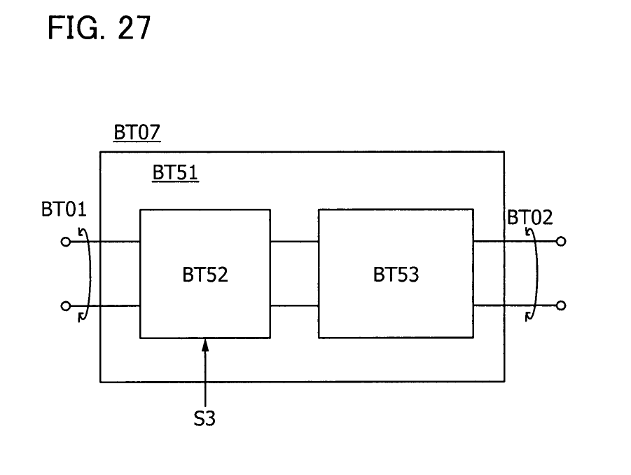

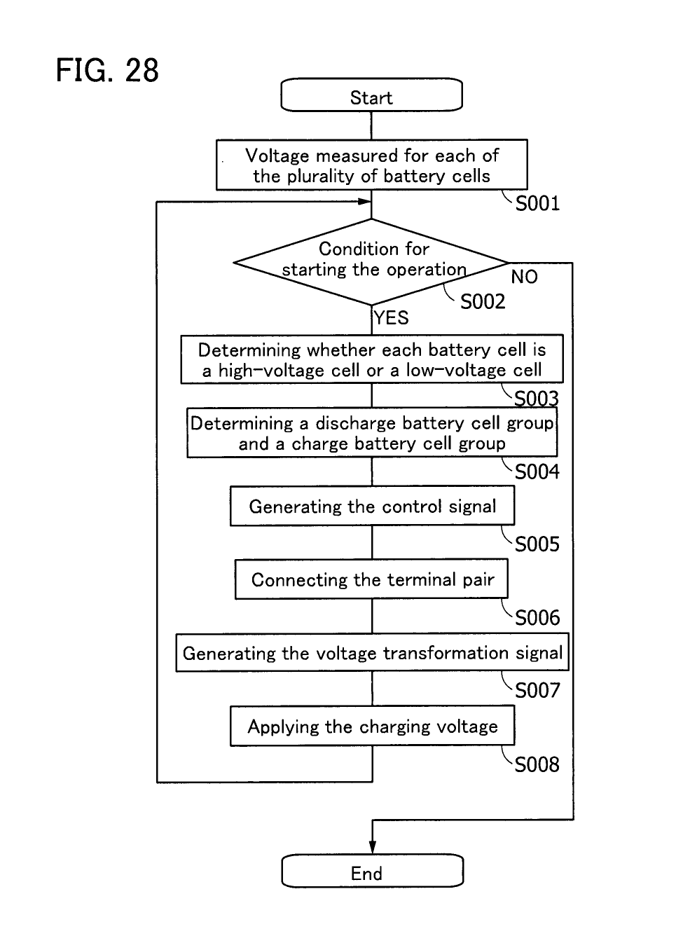

The configuration of the voltage transformer circuit BT07 including the insulated DC-DC converter is illustrated in FIG. 27. An insulated DC-DC converter BT51 includes a switch portion BT52 and a transformer BT53. The switch portion BT52 is a switch for switching on/off of the insulated DC-DC converter, and a metal oxide semiconductor field-effect transistor (MOSFET), a bipolar transistor, or the like is used as the switch portion BT52. The switch portion BT52 periodically turns on and off the insulated DC-DC converter BT51 in response to the voltage transformation signal S3 for controlling the on/off ratio which is output from the voltage transformation control circuit BT06. The switch portion BT52 can have any of various structures in accordance with the type of insulated DC-DC converter which is used. The transformer BT53 converts the discharging voltage applied from the terminal pair BT01 into the charging voltage. In detail, the transformer BT53 operates in conjunction with the on/off state of the switch portion BT52 and converts the discharging voltage into the charging voltage in accordance with the on/off ratio. As the time during which the switch portion BT52 is on becomes longer in its switching period, the charging voltage is increased. On the other hand, as the time during which the switch portion BT52 is on becomes shorter in its switching period, the charging voltage is decreased. In the case where the insulated DC-DC converter is used, the terminal pair BT01 and the terminal pair BT02 can be insulated from each other inside the transformer BT53.

A flow of operations of the power storage device BT00 in this embodiment will be described with reference to FIG. 28. FIG. 28 is a flow chart showing the flow of the operations of the power storage device BT00.

First, the power storage device BT00 obtains a voltage measured for each of the plurality of battery cells BT09 (step S001). Then, the power storage device BT00 determines whether or not the condition for starting the operation of reducing variations in voltage of the plurality of battery cells BT09 is satisfied (step S002). An example of the condition can be that the difference between the maximum value and the minimum value of the voltage measured for each of the plurality of battery cells BT09 is higher than or equal to the predetermined threshold value. In the case where the condition is not satisfied (step S002: NO), the power storage device BT00 does not perform the following operation because voltages of the battery cells BT09 are well balanced. In contrast, in the case where the condition is satisfied (step S002: YES), the power storage device BT00 performs the operation of reducing variations in the voltage of the battery cells BT09. In this operation, the power storage device BT00 determines whether each battery cell BT09 is a high voltage cell or a low voltage cell on the basis of the measured voltage of each cell (step S003). Then, the power storage device BT00 determines a discharge battery cell group and a charge battery cell group on the basis of the determination result (step S004). In addition, the power storage device BT00 generates the control signal S1 for setting the connection destination of the terminal pair BT01 to the determined discharge battery cell group, and the control signal S2 for setting the connection destination of the terminal pair BT02 to the determined charge battery cell group (step S005). The power storage device BT00 outputs the generated control signals S1 and S2 to the switching circuit BT04 and the switching circuit BT05, respectively. Then, the switching circuit BT04 connects the terminal pair BT01 and the discharge battery cell group, and the switching circuit BT05 connects the terminal pair BT02 and the discharge battery cell group (step S006). The power storage device BT00 generates the voltage transformation signal S3 based on the number of the battery cells BT09 included in the discharge battery cell group and the number of the battery cells BT09 included in the charge battery cell group (step S007). Then, the power storage device BT00 converts, in response to the voltage transformation signal S3, the discharging voltage applied to the terminal pair BT01 into a charging voltage and applies the charging voltage to the terminal pair BT02 (step S008). In this way, charge of the discharge battery cell group is transferred to the charge battery cell group.

Although the plurality of steps are shown in order in the flow chart of FIG. 28, the order of performing the steps is not limited to the order.

With this embodiment, unlike in a capacitive type circuit, a structure for temporarily storing an electric charge from the discharge battery cell group and then sending the stored electric charge to the charge battery cell group is unnecessary to transfer an electric charge from the discharge battery cell group to the charge battery cell group. Accordingly, the charge transfer efficiency per unit time can be increased. In addition, the switching circuit BT04 and the switching circuit BT05 determine which battery cell in the discharge battery cell group and the charge battery cell group to be connected to the voltage transformer circuit.

Furthermore, the voltage transformer circuit BT07 converts the discharging voltage applied to the terminal pair BT01 into the charging voltage based on the number of the battery cells BT09 included in the discharge battery cell group and the number of the battery cells BT09 included in the charge battery cell group, and applies the charging voltage to the terminal pair BT02. Thus, charge can be transferred without any problems regardless of how the battery cells BT09 are selected as the discharge battery cell group and the charge battery cell group.

Furthermore, the use of OS transistors as the transistor BT10 and the transistor BT13 can reduce the amount of charge that leaks from the battery cells BT09 not belonging to the charge battery cell group or the discharge battery cell group. Accordingly, a decrease in capacity of the battery cells BT09 which do not contribute to charging or discharging can be suppressed. In addition, the variations in characteristics of the OS transistor due to heat are smaller than those of an Si transistor. Accordingly, even when the temperature of the battery cells BT09 is increased, an operation such as turning on or off the transistors in response to the control signals S1 and S2 can be performed normally.

### EXAMPLE

In this example, the characteristics of a positive electrode including a mixture of a lithium-manganese composite oxide and a lithium-manganese oxide with a spinel crystal structure as a positive electrode active material will be described.

### [Formation of Positive Electrode]

First, steps for forming a lithium-manganese composite oxide that is one of materials used for a positive electrode active material in this example will be described.

First, materials Li₂CO₃, MnCO₃, and NiO were weighed so that the molar ratio thereof was 1:0.99:0.01. This is in order to form a lithium-manganese composite oxide having a composition of Li₂Mn_{0.99}Ni_{0.01}O₃.

The weighed materials, a zirconia ball with a diameter of 3 mm, and acetone were put into a pot made of zirconia, and wet ball milling using a planetary ball mill was performed at 400 rpm for 2 hours (Step 1).

Then, acetone in slurry subjected to the ball milling was volatilized at 50° C. in the air to obtain a mixed material (Step 2).

Next, an alumina crucible was filled with the mixed material from which a solvent has been volatilized, and firing was performed at 800° C. for 10 hours in the air to obtain an objective (Step 3).

Subsequently, grinding was performed to separate the sintered particles. The fired materials, zirconia balls with a diameter of 3 mm and a diameter of 10 mm respectively, and acetone were put into a pot made of zirconia, and wet ball milling using a planetary ball mill was performed at 400 rpm for 2 hours (Step 4).

The ground slurry was heated at 50° C. in the air to volatilize acetone from the slurry (Step 5). After that, a solvent was evaporated in vacuum (Step 6). Through the above steps, the lithium-manganese composite oxide, which is one of materials used as a positive electrode active material, was formed.

Next, a lithium-manganese oxide with a spinel crystal structure that is to be mixed with the lithium-manganese composite oxide will be described. For the lithium-manganese oxide with a spinel crystal structure, LiMn₂O₄ was used.

In this example, the lithium-manganese composite oxide and the lithium-manganese oxide with a spinel crystal structure were used as a positive electrode active material, and polyvinylidene fluoride (PVdF) was used as a binder. The mixture ratio (weight ratio) of the lithium-manganese composite oxide to the lithium-manganese oxide with a spinel crystal structure was 70:30, and this mixture material, acetylene black, and polyvinylidene fluoride were mixed at a ratio (weight ratio) of 90:5:5. As a disperse medium for viscosity adjustment, NMP was added to and mixed with the mixture. Thus, a positive electrode paste was formed. The positive electrode paste was applied to a positive electrode current collector (20 μm-thick aluminum), and a solvent was evaporated at 80° C. for 40 minutes. After that, the solvent was evaporated at 170° C. for 10 hours in a reduced pressure environment. Thus, a positive electrode active material layer was formed. Through the above steps, a positive electrode (Positive Electrode 1 of Example) was formed.

Next, a half cell including the positive electrode was formed and was charged and discharged. The evaluation was performed using a coin cell. In the coin cell, a lithium metal was used for a negative electrode, polypropylene (PP) was used for a separator, and an electrolytic solution was formed in such a manner that lithium hexafluorophosphate (LiPF₆) was dissolved at a concentration of 1 mol/L in a solution in which ethylene carbonate (EC) and diethyl carbonate (DEC) were mixed at a volume ratio of 1:1 was used. Charging was performed at a constant current and a rate of 0.2 C (it takes five hours for charging) until the voltage reached a termination voltage of 4.8 V. Discharging was performed at a constant current and a rate of 0.2 C (it takes five hours for discharging) until the voltage reached a termination voltage of 2 V. The environmental temperature was set at 25° C.

FIG. 17 shows the obtained initial charge and discharge characteristics. As comparative examples, a positive electrode in which the above lithium-manganese composite oxide was used alone as a material for a positive electrode active material (Comparative Positive Electrode 1) and a positive electrode in which the above lithium-manganese oxide with a spinel crystal structure was used alone as a material for a positive electrode active material (Comparative Positive Electrode 2) were formed, and the charge and discharge characteristics thereof measured in a similar manner are also shown in FIG. 17. Furthermore, the charge and discharge capacities of each of the materials for the positive electrode active material obtained by measurement of the charge and discharge characteristics are shown in Table 1.

TABLE 1

| | Comparative | Positive | Comparative |
|---|---|---|---|
| | Positive | Electrode 1 | Positive |
| | Electrode 1 | of Example | Electrode 2 |
| Compounding Ratio | 100:0 | 70:30 | 0:100 |
| (Lithium-manganese | | | |
| composite oxide:Lithium- | | | |
| manganese oxide with spinel | | | |
| crystal structure) | | | |
| Charge capacity (mAh/g) | 365.72 | 201.76 | 130.44 |
| Discharge capacity (mAh/g) | 218.57 | 165.48 | 232.15 |

As shown in FIG. 17, the charge capacity of the positive electrode in which the lithium-manganese composite oxide was used alone as the material for the positive electrode active material (Comparative Positive Electrode 1) is much higher than the discharge capacity thereof. In the case where the positive electrode is used for a lithium-ion storage battery, the charge capacity of the positive electrode is high and thus the capacity of a negative electrode should also be high; however, the discharge capacity per unit weight of the positive electrode active material is relatively low. Thus, the capacity of the lithium-ion storage battery is low. When a larger amount of negative electrode material is used in order to increase the capacity of the negative electrode, the capacity per unit weight of the storage battery is reduced accordingly.

The charge capacity of the positive electrode in which the lithium-manganese oxide with a spinel crystal structure was used alone as the material for the positive electrode active material (Comparative Positive Electrode 2) is lower than the discharge capacity thereof. In the case where the positive electrode is used for a lithium-ion storage battery, the charge capacity of the positive electrode is low and thus the lithium-ion storage battery cannot be charged such that the discharge capacity is utilized without waste. As a result, the capacity of the storage battery is reduced.

In contrast, in the case of the positive electrode in which the lithium-manganese composite oxide and the lithium-manganese oxide with a spinel crystal structure were used as the materials for the positive electrode active material (Positive Electrode 1 of Example), the difference between the discharge capacity and the charge capacity is small. Therefore, in the case where the positive electrode is used for a lithium-ion storage battery, a large amount of negative electrode active material is not needed like in the case where the lithium-manganese composite oxide is used alone for the positive electrode active material. Furthermore, high discharge capacity can be further utilized without restriction due to low charge capacity, unlike in the case where the lithium-manganese oxide with a spinel crystal structure is used alone for the positive electrode active material.

Detailed description is made below. As shown in Table 1, the charge capacity of Comparative Positive Electrode 1 is higher than the discharge capacity thereof by 147.15 mAh/g; thus, in the lithium-ion storage battery including this positive electrode, a material for a negative electrode active material which does not contribute to repeated charging and discharging is needed accordingly, and as a result, the weight of the lithium-ion storage battery is increased. The charge capacity of Comparative Positive Electrode 2 is lower than the discharge capacity thereof by 115.44 mAh/g, which does not contribute to repeated charging and discharging and cannot be utilized.

In contrast, the charge capacity of Positive Electrode 1 of Example is higher than the discharge capacity thereof by only 36.28 mAh/g as shown in Table 1; the difference between the charge capacity and the discharge capacity is much smaller than those in Comparative Positive Electrode 1 and Comparative Positive Electrode 2. Therefore, in the lithium-ion storage battery including Positive Electrode 1 of Example, a large amount of material for the negative electrode active material is not needed and thus the lithium-ion storage battery can be lightweight. Furthermore, the discharge capacity of the material for the positive electrode active material can be sufficiently utilized.

The lithium-ion storage battery including Positive Electrode 1 of Example has an effect due to one embodiment of the present invention; the mixture ratio (weight ratio) of the lithium-manganese composite oxide to the lithium-manganese oxide with a spinel crystal structure in Positive Electrode 1 of Example is 70:30. When the mixture ratio (weight ratio) of the lithium-manganese composite oxide to the lithium-manganese oxide with a spinel crystal structure is calculated by Formula (1) described in Embodiment 1 using the values in Table 1, the optimal mixture ratio (weight ratio) of the lithium-manganese composite oxide to the lithium-manganese oxide with a spinel crystal structure turns out to be approximately 59:51. Therefore, when a positive electrode with a mixture ratio (weight ratio) of 59:51 is used for a lithium-ion storage battery, an effect due to one embodiment of the present invention is expected to be more noticeable.

This application is based on Japanese Patent Application serial no. 2014-264207 filed with Japan Patent Office on Dec. 26, 2014, the entire contents of which are hereby incorporated by reference.

What is claimed is:

1. A lithium-ion storage battery comprising:
a positive electrode;
a negative electrode; and
an electrolytic solution between the positive electrode and the negative electrode,
wherein the positive electrode comprises:
a positive electrode current collector; and
a positive electrode active material layer,
wherein the positive electrode active material layer comprises:
a first positive electrode active material; and
a second positive electrode active material,
wherein a charge capacity of the first positive electrode active material is higher than a discharge capacity of the first positive electrode active material, and
wherein a discharge capacity of the second positive electrode active material is higher than a charge capacity of the second positive electrode active material.

2. The lithium-ion storage battery according to any one of claim 1,
wherein the first positive electrode active material is a lithium-manganese composite oxide, and
wherein the second positive electrode active material is a lithium-manganese oxide with a spinel crystal structure.

3. A lithium-ion storage battery comprising:
a positive electrode;
a negative electrode; and
an electrolytic solution between the positive electrode and the negative electrode,
wherein the positive electrode comprises:
a positive electrode current collector; and
a positive electrode active material layer,
wherein the positive electrode active material layer comprises:
a first positive electrode active material; and
a second positive electrode active material,
wherein a charge capacity of the first positive electrode active material is higher than a discharge capacity of the first positive electrode active material,
wherein a discharge capacity of the second positive electrode active material is higher than a charge capacity of the second positive electrode active material,
wherein a difference between the charge capacity and the discharge capacity of the first positive electrode active material is larger than a difference between the discharge capacity and the charge capacity of the second positive electrode active material, and
wherein a proportion of the first positive electrode active material is higher than a proportion of the second positive electrode active material in the positive electrode active material layer.

4. The lithium-ion storage battery according to any one of claim 3,
wherein the first positive electrode active material is a lithium-manganese composite oxide, and
wherein the second positive electrode active material is a lithium-manganese oxide with a spinel crystal structure.

5. A lithium-ion storage battery comprising:
a positive electrode;
a negative electrode; and
an electrolytic solution between the positive electrode and the negative electrode,
wherein the positive electrode comprises:
a positive electrode current collector; and
a positive electrode active material layer,
wherein the positive electrode active material layer comprises:
a first positive electrode active material; and
a second positive electrode active material,
wherein a charge capacity of the first positive electrode active material is higher than a discharge capacity of the first positive electrode active material,
wherein a discharge capacity of the second positive electrode active material is higher than a charge capacity of the second positive electrode active material, and
wherein a capacity obtained by multiplying a difference between the charge capacity and the discharge capacity of the first positive electrode active material by a weight proportion of the first positive electrode active material in the positive electrode active material layer is lower than or equal to a capacity obtained by multiplying a difference between the discharge capacity and the charge capacity of the second positive electrode active material by a weight proportion of the second positive electrode active material in the positive electrode active material layer.

6. The lithium-ion storage battery according to any one of claim 5,
wherein the first positive electrode active material is a lithium-manganese composite oxide, and
wherein the second positive electrode active material is a lithium-manganese oxide with a spinel crystal structure.

7. A lithium-ion storage battery comprising:
a positive electrode;
a negative electrode; and
an electrolytic solution between the positive electrode and the negative electrode,
wherein the positive electrode comprises:
a positive electrode current collector; and
a positive electrode active material layer,
wherein the positive electrode active material layer comprises:
a first positive electrode active material; and
a second positive electrode active material,
wherein a charge capacity of the first positive electrode active material is higher than a discharge capacity of the first positive electrode active material,
wherein a discharge capacity of the second positive electrode active material is higher than a charge capacity of the second positive electrode active material,
wherein a difference between the charge capacity and the discharge capacity of the first positive electrode active material is larger than a difference between the discharge capacity and the charge capacity of the second positive electrode active material, and
wherein a proportion of the first positive electrode active material in the positive electrode active material layer satisfies Formula (1):
$${R}_{1} = \frac{( {Q}_{c 2} - {Q}_{d 2} )}{( {Q}_{c 2} - {Q}_{d 2} ) - ( {Q}_{c 1} - {Q}_{d 1} )} , \qquad ( 1 )$$
wherein R₁ represents a weight proportion of the first positive electrode active material in the positive electrode active material layer,
wherein Q_{c1}represents the charge capacity of the first positive electrode active material, and Q_{d1} represents the discharge capacity of the first positive electrode active material, and
wherein Q_{c2} represents the charge capacity of the second positive electrode active material, and Q_{d2} represents the discharge capacity of the second positive electrode active material.

8. The lithium-ion storage battery according to any one of claim 7,
wherein the first positive electrode active material is a lithium-manganese composite oxide, and
wherein the second positive electrode active material is a lithium-manganese oxide with a spinel crystal structure.
